(19) United States
(12) Patent Application Publication
(10) Pub. No.: US 2015/0051959 A1
(43) Pub. Date: Feb. 19, 2015

(54) INFORMATION PROCESSING DEVICE AND METHOD, PROGRAM, AND INFORMATION PROCESSING SYSTEM

(71) Applicant: Sony Corporation, Tokyo (JP)

(72) Inventors: Masanobu Yamashita, Tokyo (JP); Ko Shikita, Saitama (JP); Ko Kobayashi, Tokyo (JP); Fumiaki Suzuki, Tokyo (JP)

(21) Appl. No.: 14/381,083

(22) PCT Filed: Mar. 13, 2013
(86) PCT No.: PCT/JP2013/056947

§ 371 Date: Aug. 26, 2014

(30) Foreign Application Priority Data
Mar. 21, 2012 (JP) 2012-063076

(51) Int. Cl. G06Q 30/02

(52) U.S. Cl. CPC G06Q 30/0277; G06Q 30/0214
USPC 705/14.16; 705/14.73

(57) ABSTRACT

There is provided an information processing device including an association unit configured to associate content of which a first post destination is designated by a first user with a predetermined advertisement, and a transmission control unit configured to transmit the content associated with the predetermined advertisement by the association unit to the first post destination as affiliate content, and when the affiliate content is reproduced in the first post destination and then a second post destination is designated by a second user, to transmit a duplicate of the affiliate content of which the second post destination has been designated to the second post destination.

### TECHNICAL FIELD

The present technology relates to an information processing device and method, a program, and an information processing system, and particularly to an information processing device and method, a program, and an information processing system through which a link to an advertisement site can be posted on multimedia content created by an individual.

### BACKGROUND ART

As an advertising method on the Internet in the related art, an affiliate advertisement method has been widely known. In the affiliate advertisement method, an advertiser pays a reward to an administrator of content that is the source of a link under the condition that viewers of the content view the advertising site via the link posted on the content or register as members in the advertisement site.

Patent Literature 1 describes the technology in which text that relates to an advertisement site is detected from a comment written by a user and a link to the advertisement site is automatically posted on the detected text.

Patent Literature 2 describes the technology in which metadata such as tags embedded in advance in multimedia content including an image, a sound, or the like is read and a link that relates to the read metadata is posted.

### CITATION LIST

### Patent Literature

Patent Literature 1: JP 2010-086331A

Patent Literature 2: JP 2011-517812A

### SUMMARY OF INVENTION

### Technical Problem

However, such content created by an individual is not limited to text content, and can also be multimedia content. It is difficult to apply the method described in

Patent Literature 1 to posting of a link to an advertisement site on such multimedia content.

In addition, since most kinds of such multimedia content created by individuals do not have metadata embedded therein in advance, it is difficult to apply the method described in Patent Literature 2.

As described above, it is desired to post a link to an advertisement site of an advertiser who advertises using the affiliate advertisement method on such multimedia content created by an individual, but such a desire is currently not fully satisfied.

In consideration of the circumstances, the present technology aims to enable posting of a link to an advertisement site on multimedia content created by an individual.

### Solution to Problem

According to an aspect of the present disclosure, there is provided an information processing device including an association unit configured to associate content of which a first post destination is designated by a first user with a predetermined advertisement, and a transmission control unit configured to transmit the content associated with the predetermined advertisement by the association unit to the first post destination as affiliate content, and when the affiliate content is reproduced in the first post destination and then a second post destination is designated by a second user, to transmit a duplicate of the affiliate content of which the second post destination has been designated to the second post destination.

The information processing device may further include an extraction unit configured to extract a keyword by analyzing the content. When the keyword extracted by the extraction unit coincides with a keyword that relates to the predetermined advertisement, the association unit may associate the content and the predetermined advertisement.

The transmission control unit may perform redirection to the predetermined advertisement when an instruction to reproduce the affiliate content is accepted.

The information processing device may further include a reward calculation unit configured to record a number of times of reproduction of the predetermined advertisement after the instruction to reproduce the affiliate content is accepted and then to calculate an amount to be claimed to an advertiser based on the number of times.

The reward calculation unit may calculate amounts of rewards for each of the first user and the second user based on the amount to be claimed.

An information processing method and a program of an aspect of the present technology are a method and a program corresponding to the information processing device of the aspect of the present technology described above.

In the information processing device and method and the program of the aspect of the present technology, the content of which the first post destination is designated by the first user is associated with the predetermined advertisement, the content associated with the predetermined advertisement is transmitted to the first post destination as affiliate content, and when the affiliate content is reproduced in the first post destination and the second post destination is designated by the second user, a duplicate of the affiliate content of which the second post destination has been designated is transmitted to the second post destination.

An information processing system of an aspect of the present technology includes a user terminal that has an acceptance unit that accepts designation of a first post destination of content from a first user and a transmission control unit that transmits the content of which the first post destination is designated to a server, and a server that has an association unit that associates the content that is received from the user terminal and of which the first post destination is designated by the first user with a predetermined advertisement, and a transmission control unit that transmits the content associated with the predetermined advertisement by the association unit to the first post destination as affiliate content, and when the affiliate content is reproduced in the first post destination and then a second post destination is designated by a second user, transmits a duplicate of the affiliate content of which the second post destination has been designated to the second post destination.

In the information processing system of the aspect of the present technology, in the first user terminal, designation of the first post destination of the content is accepted from the first user and the content of which the first post destination has been designated is transmitted, and in the server, the content of which the first post destination has been designated is received, the content of which the first post destination has been designated is associated with the predetermined advertisement, the content associated with the predetermined advertisement is transmitted to the first post destination as affiliate content, and when the affiliate content is reproduced in the first post destination and the second post destination is designated by the second user, a duplication of the affiliate content of which the second post destination has been designated is transmitted to the second post destination.

### Advantageous Effects of Invention

According to the present technology, a link to an advertisement site can be posted on multimedia content created by an individual.

### BRIEF DESCRIPTION OF DRAWINGS

FIG. 1 is a diagram describing an overview of the present technology.

FIG. 2 is a block diagram showing a configuration of an information processing system 1.

FIG. 3 is a block diagram showing a hardware configuration example of a server.

FIG. 4 is a diagram showing a detailed configuration of a plurality of DBs.

FIG. 5 is a block diagram showing a hardware configuration example of a user terminal.

FIG. 6 is a block diagram showing a functional configuration example of a CPU of the server.

FIG. 7 is a block diagram showing a functional configuration example of a CPU of the user terminal.

FIG. 8 is a block diagram showing a functional configuration example of the CPU of the server and the CPU of the user terminal for realizing a first-order user registration process.

FIG. 9 is a flowchart describing the flow of the first-order user registration process.

FIG. 10 is a flowchart describing the flow of a second-order user registration process.

FIG. 11 is a block diagram showing a functional configuration example of the CPU of the server and the CPU of the user terminal for realizing the first-order registration process of content.

FIG. 12 is a flowchart describing the flow of the first-order registration process of content.

FIG. 13 is a block diagram showing a functional configuration example of the CPU of the server and the CPU of another user terminal for realizing a reuse process.

FIG. 14 is a flowchart describing the flow of the reuse process.

FIG. 15 is a block diagram showing a functional configuration example of the CPU of the server and the CPU of the user terminal for realizing an advertisement page display process.

FIG. 16 is a flowchart describing the flow of the advertisement page display process.

FIG. 17 is a block diagram showing a functional configuration example of the CPU of the server and the CPU of the user terminal for realizing a reward distribution process.

FIG. 18 is a flowchart describing the flow of the reward distribution process.

### DESCRIPTION OF EMBODIMENTS

### [Overview of the Present Technology]

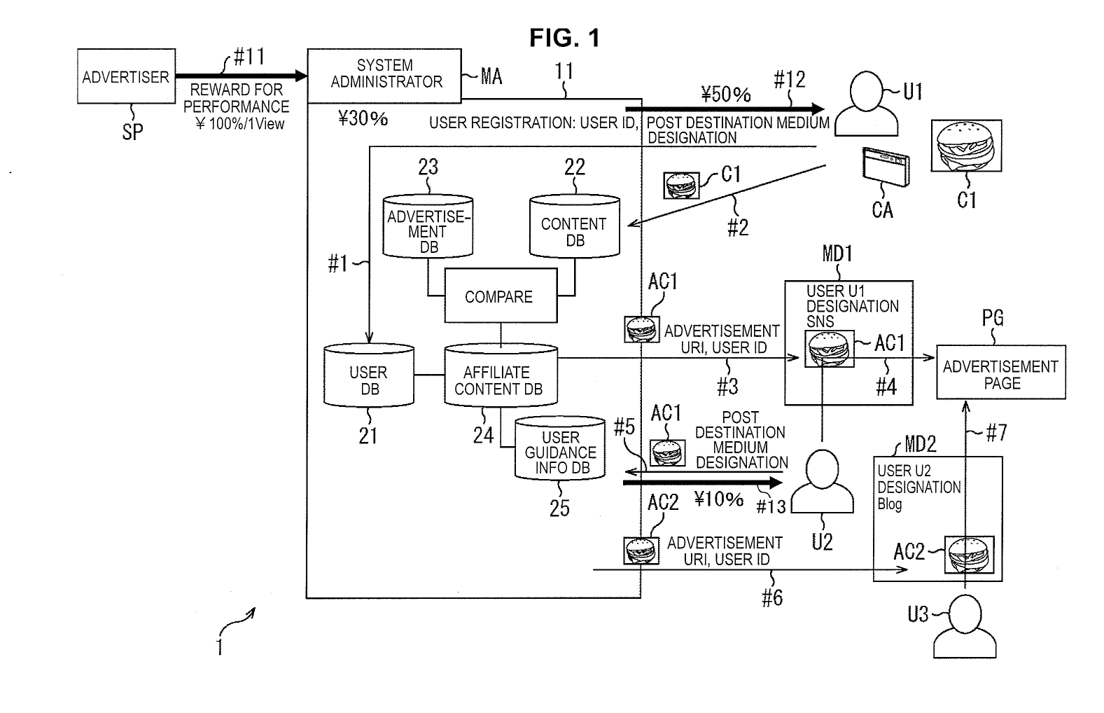

FIG. 1 shows an example of a model realized by an information processing system 1 to which the present technology is applied.

In the model of the present technology, the substance of image or sound content generated by a user (hereinafter appropriately referred to as UGC (User Generated Content)) is analyzed, and on the UGC, a link to an advertisement site of a company (in other words, an advertiser) that relates to the analyzed substance is posted. Then, when the UGC on which the link of the advertisement site is posted is uploaded on a network, it can be viewed by another user. The other user views the advertisement site via the link posted on the UGC, and he or she can do a certain action of registering as a member or purchasing a product on the advertisement site. When such an advertisement site is viewed, a reward is paid to the user. In other words, the UGC is an advertisement medium serving as an affiliate medium.

Participants of the model of the present technology are one or more advertisers (one advertiser SP in the example of FIG. 1), one or more system administrators (one system administrator MA in the example of FIG. 1), and one or more users (three users U1 to U3 in the example of FIG. 1) as shown in FIG. 1. Note that, when it is not necessary to distinguish between the users U1 to U3, they are hereinafter collectively referred to as users U.

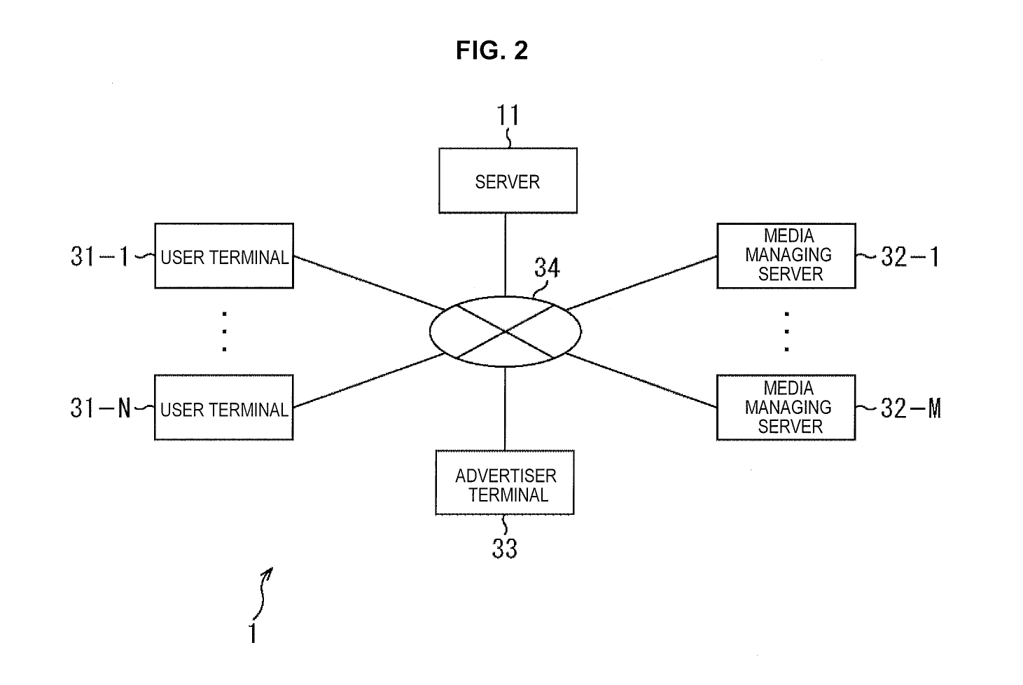

The advertiser SP manages an advertisement page PG of its own using an advertiser terminal (an advertiser terminal 33 that will be described later in FIG. 2 and so on), and requests the system administrator MA to perform the task of posting the link of the advertisement page PG on various kinds of UGC.

When receiving the request of the advertiser SP, the system administrator MA performs, on UGC generated by, for example, a user U1, the task of posting the link of the advertisement page PG that is, the task of connecting the UGC and the advertisement page PG using a server 11. Then, the system administrator MA causes the UGC associated with the advertisement page PG to be reproduced in a medium on a network designated in advance by the user U1 (hereinafter referred to as a post destination medium) using the server 11. The medium is, for example, an SNS (social networking service) such as Facebook or mixi, or a blog.

The server 11 managed by the system administrator MA has a user DB 21, a content DB 22, an advertisement DB 23, an affiliate content DB 24, and a user guidance information DB 25.

The user DB 21 stores information of a plurality of users U for which the server 11 has completed user registration. In the example of FIG. 1, user registration of the user UI has already been performed as indicated by the arrow #1. The user DB 21 stores the user ID of the user U1 and information of a post destination medium designated by the user U1.

The content DB 22 stores UGC of a plurality of users U. In the example of FIG. 1, the user U1 transmits UGC that he or she has generated using a user terminal (a user terminal 31-1 that will be described later), to be specific, content C1 of an image of a hamburger captured using a camera CA, to the server 11 as indicated by the arrow #2. Upon receiving the content C1, the server 11 stores the content in the content DB 22.

The advertisement DB 23 stores information of the advertiser SP. In the example of FIG. 1, the advertisement DB 23 stores the advertisement ID of the advertisement page PG, the URI (Uniform Resource Identifier) of the advertisement page PG, the ID of the advertiser SP, and keywords relating to the advertisement page PG

When the content C1 is stored in the content DB 22, the server 11 analyzes the substance of the content C1, and then extracts a keyword from the content C1 based on the analysis result.

Here, since the content C1 is multimedia content including an image or a sound, text that is the keyword itself is not included therein. The server 11 analyzes the substance of the content C1, for example, the substance obtained by recognizing a character string included as a part of an image, the substance obtained by recognizing a reflection as a background of the image, the substance obtained by analyzing position information of the image, the substance obtained by analyzing a sound, or the like. In addition, when the content C1 is transmitted from the user UI and a comment is input at the same time, the server 11 analyzes the substance obtained by analyzing the comment. By analyzing the comment, accuracy of the analysis is supplemented.

Note that content used as above including the content C1 is multimedia content and can also include a sound, but will be treated as an image hereinafter for the sake of simple description.

The server 11 specifies text relating to the substance obtained by analyzing the content C1 using an arbitrary method, and extracts the text as a keyword of the content C1.

Then, the server 11 compares the extracted keyword to a keyword relating to the advertisement page PG stored in the advertisement DB 23.

When the extracted keyword coincides with the keyword relating to the advertisement page PG, the server 11 associates the content C1 with the URI of the advertisement page PG. Since content AC1 associated with the URI of the advertisement page PG (in other words, on which a link is posted) as described above functions as an affiliate medium as described above, it is referred to as affiliate content AC1 hereinbelow. In other words, the server 11 creates the affiliate content AC1 by associating the content C1 with the URI of the advertisement page PG.

Furthermore, the server 11 reads the user ID of the user U1 from the user DB 21, and then gives the user ID to the affiliate content AC1.

The server 11 transmits the affiliate content AC1 to which the user ID is given to a server that manages the post destination medium designated by the user U1 (hereinafter referred to as a media managing server).

In the case of FIG. 1, the user U1 designates a post destination medium MDI as an SNS in advance. For this reason, the affiliate content AC1 is transmitted to the media managing server (a media managing server 32-1 that will be described later) that manages the post destination medium MD1 as indicated by the arrow #3. Accordingly, the affiliate content AC1 is shared by another user, for example, the user U2 in the post destination medium MDI . In other words, the user U2 can view the affiliate content AC1 displayed on his or her user terminal (a user terminal 31-2 that will be described later).

Here, the user U2 is assumed to perform a manipulation of selecting (clicking or the like) the affiliate content AC1 using his or her user terminal while viewing the affiliate content AC1 on the post destination medium MD1. In this case, re-directing to the advertisement page PG present in the URI associated with the affiliate content AC1 is performed and thus the advertisement page PG is displayed on a display of the user terminal of the user U2 as indicated by the arrow #4. This means that the user U2 is attracted to the advertisement page PG of the advertiser SP. At this moment, the server 11 stores the number of times the affiliate content AC1 guides other users U to the advertisement page PG in the user guidance information DB 25.

Note that, at the time at which the user U2 performs the manipulation of selecting (clicking or the like) the affiliate content AC1, a reward may be paid to the user U1, but herein a reward is set to be periodically paid for the following reason. That is, there are cases in which the affiliate content AC1 is reused by other users U including the user U2 herein. Reuse here refers to placing the affiliate content AC1 in a state in which it is displayable in a post destination medium designated by users U other than the user U1 who has created the affiliate content AC1, that is, other users U (herein, a state in which the affiliate content is uploaded and shared by a plurality of users). In this case, the manipulation of selection (clicking or the like) can also occur for the reused affiliate content AC1 in the future. Thus other users U who reuse the affiliate content AC1 are also added as recipients of the payment of the reward. For this reason, rewards are set to be periodically paid also taking the circumstances of reuse of the affiliate content AC1 into consideration in the present embodiment.

Furthermore, hereinbelow, the reuse of the affiliate content AC1 by the user U2 will be described in detail. Note that the user U2 is also set to be registered as a user, in addition to the user U1, and the user DB 21 is set to store the user ID of the user U2, information of the post destination medium designated by the user U2 and the like as indicated by the arrow #5.

The user U2 transmits a request to reuse the affiliate content AC1 to the server 11 through a predetermined manipulation using his or her user terminal while viewing the affiliate content AC1 via the post destination medium MDI. Then, the server 11 duplicates the affiliate content AC1 to create affiliate content AC2. Furthermore, the server 11 reads the user ID of the user U2 from the user DB 21 and gives the user ID to the affiliate content AC2. The server 11 transmits the affiliate content AC2 to which the user ID has been given to a media managing server that manages a post destination medium designated by the user U2.

In the case of FIG. 1, the user U2 designates the post destination medium MD2 as a blog in advance. For this reason, the affiliate content AC2 is transmitted to the media managing server (media managing server 32-2 that will be described later) that manages the post destination medium MD2 as indicated by the arrow #6. Accordingly, the affiliate content AC2 is shared with yet another user U, for example, the user U3 in the post destination medium MD2. In other words, the user U3 can view the affiliate content AC2 displayed on his or her user terminal (user terminal 31-3 that will be described later).

Here, the user U3 is assumed to perform a manipulation of selecting (clicking or the like) the affiliate content AC2 using his or her user terminal while viewing the affiliate content AC2 on the post destination medium MD2. In this case, redirection to the advertisement page PG present in the URI associated with the affiliate content AC2 is performed as indicated by the arrow #7 and the advertisement page PG is displayed on a display of the user terminal of the user U2. This means that the user U3 is attracted to the advertisement page PG of the advertiser SP. At this moment, the server 11 stores the number of times the affiliate content AC2 guides other users U to the advertisement page PG in the user guidance information DB 25.

The user U3 can also reuse the affiliate content AC2 in the same manner, and a number of other users Uk (the value of k is an integer equal to or greater than 2) not shown in FIG. 1 can also reuse affiliate content ACk. Consequently, the original and a duplicate of the content C1 associated with the URI of the advertisement page PG, in other words, affiliate content AC1 to ACN (the value of N is an arbitrary integer equal to higher than 1), is proliferated in various post destination media (including the post destination media MD1 and MD2 of FIG. 1) on a network while the number (=N) of pieces of the content increases. In this case, since the content is viewed by a large number of users U, attraction of a large number of users to the advertisement page PG can be expected.

Here, in principle, the user U1 who has created the content C1 can acquire the reward according to the number of views under the condition that other users U view the advertisement page PG via the affiliate content AC1 that is the original created based on the content C1.

In addition, the user U2 can acquire the reward according to the number of views under the condition that other users U view the advertisement page PG via the affiliate content AC2 that is a duplicate of the affiliate content AC1 in principle.

The method of distributing the reward is not particularly limited. In the example of FIG. 1, the degrees of contribution to guiding users to the advertisement page PG are assigned in advance to each of the user U1 to a user UN who have used or reused the affiliate content AC1 to ACN, respectively. The total amount of rewards is divided based on the degree of contribution and distributed to each of the users U. A method of setting the degree of contribution of this case is not particularly limited, but in the example of FIG. 1, a method of setting the user U1 who has created the content C1 serving as the source of the affiliate content AC1 that is the original to have a higher degree of contribution as a valuable entity than the users U2 to UN who simply reuse the duplicated affiliate content AC2 to ACN is applied.

To be specific, a degree of contribution of 50% is attributed to the user U1 on the premise that a degree of contribution of 30% is attributed to the system administrator MA who has contributed to some degree. Then, the remaining degree of contribution of 20% assigned at a predetermined ratio is attributed to other users U2 to UN. In the example of FIG. 1, 10% of the degree of contribution is assigned to the user U2 who has reused the content and the remaining 10% is assigned to other unillustrated users U who have reused the content.

In this case, the system administrator MA counts the number of times users are guided to the advertisement page PG, i.e., the number of views of the advertisement page PG based on the information stored in the user guidance information DB 25 using the server 11. Then, the system administrator MA claims the amount to be charged according to the number of views of the advertisement page PG to the advertiser SP.

The advertiser SP pays the reward equivalent to the amount of rewards to the system administrator MA as indicated by the arrow #11.

Then, the system administrator MA distributes the reward remaining after the reward for the system administrator MA is deducted from the total reward that the advertiser SP has paid to each of the plurality of users U according to their performance using the server 11.

To be specific, the server 11 deducts 30% from the reward paid by the advertiser SP for one view of the advertisement page PG as the reward for the system administrator MA.

Then, the server 11 distributes the remaining reward to the plurality of users U based on the information stored in the user guidance information DB 25. In other words, 50% of the total reward is paid to the user U1 as indicated by the arrow #12, and 10% of the total reward is paid to the user U2 as indicated by the arrow #13. In addition, the remaining 10% is paid to each of other unillustrated users UN.

As described above, according to the information processing system 1, the URI of the advertisement page PG can be retrospectively associated with UGC such as multimedia content. In addition, the reward from the advertiser SP can be distributed to the users U who share the UGC in multiple stages.

Note that a user U such as the user U1 who generates the content C1 associated with the URI of the advertisement page PG and transmits the content to the server 11, i.e., the user U1 who is the so-called creator of the affiliate content AC1 that is the original, will hereinafter be referred to as a first-order user. On the other hand, a user U such as the user U2 who reuses the affiliate content AC1 that is a duplicate of the affiliate content AC1 that is the original will hereinafter be referred to as a second-order user. In addition, a user U who views affiliate content ACk will hereinafter be referred to as a viewer-user.

### [Configuration Example of the Information Processing System]

FIG. 2 is a block diagram showing a configuration of the information processing system 1.

The information processing system 1 is constituted by the server 11, user terminals 31-1 to 31-N (the value of N is an arbitrary integer equal to or greater than 1), media managing servers 32-1 to 32-M (the value of M is an arbitrary integer equal to or greater than 1), and the advertiser terminal 33 which are connected to one another via a network 34. Note that, when it is not necessary to distinguish each of the user terminals 31-1 to 31-N below, they are collectively referred to as user terminals 31. In addition, when it is not necessary to distinguish each of the media managing servers 32-1 to 32-M, they are collectively referred to as media managing servers 32.

### [Hardware Configuration Example of the Server]

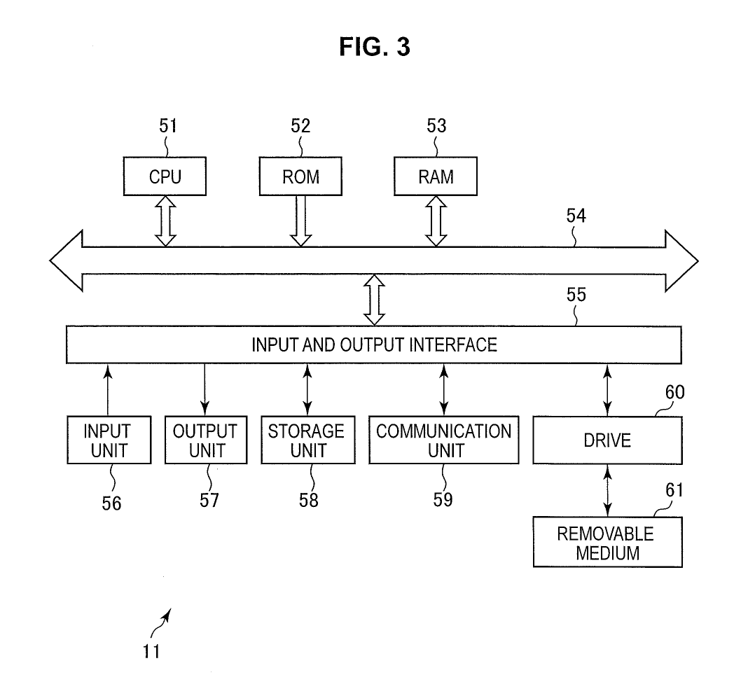

FIG. 3 is a block diagram showing a hardware configuration example of the server 11.

The server 11 includes a CPU (Central Processing Unit) 51, a ROM (Read Only Memory) 52, a RAM (Random Access Memory) 53, a bus 54, an input and output interface 55, an input unit 56, an output unit 57, a storage unit 58, a communication unit 59, and a drive 60.

The CPU 51 executes various processes according to programs recorded in the ROM 52. Alternatively, the CPU 51 executes various processes according to programs loaded on the RAM 53 from the storage unit 58. In addition, the RAM 53 also appropriately stores data and the like necessary for the CPU 51 to execute various processes.

The CPU 51, the ROM 52, and the RAM 53 are connected to one another via the bus 54. In addition, the bus 54 is also connected to the input and output interface 55. The input and output interface 55 is connected to the input unit 56, the output unit 57, the storage unit 58, and the communication unit 59.

The input unit 56 includes a keyboard, a mouse, a microphone, and the like. The output unit 57 includes a display, a speaker, and the like, and outputs various images.

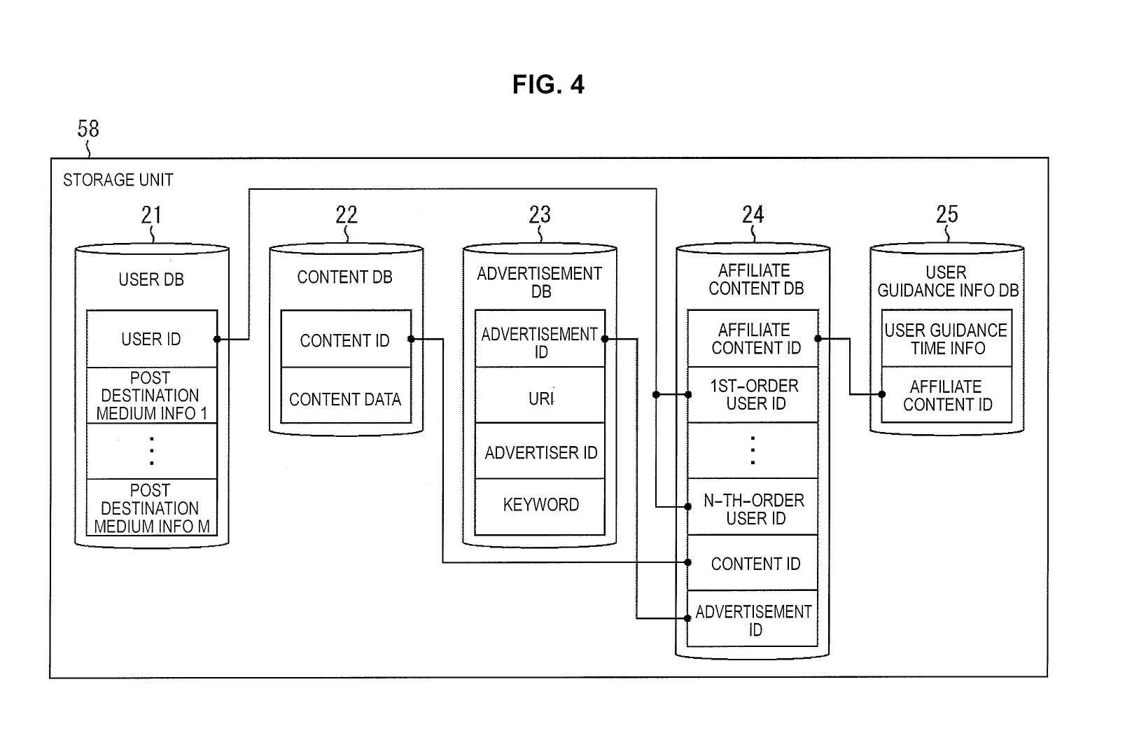

The storage unit 58 includes, for example, a hard disk, a non-volatile memory, or the like, storing various kinds of information and a plurality of DBs. Details of the DBs will be described later with reference to FIG. 4.

The communication unit 59 controls communication performed between the user terminals 31, the media managing servers 32, and the advertiser terminal 33 via the network 34 including the Internet.

The input and output interface 55 is also connected to the drive 60 if necessary, in which a removable medium 61 including a magnetic disk, an optical disc, a magneto-optical disc, or a semiconductor memory is appropriately mounted. In addition, a computer program read from the medium is installed in the storage unit 58 if necessary.

### [Details of DB]

FIG. 4 is a diagram showing a detailed configuration of the plurality of DBs provided in the storage unit 58.

The storage unit 58 stores the user DB 21, the content DB 22, the advertisement DB 23, the affiliate content DB 24, and the user guidance information DB 25.

The user DB 21 stores user IDs, and pieces of post destination media information 1 to M (the value of M is an arbitrary integer equal to or greater than 1). The user IDs are information for identifying users. The pieces of post destination media information 1 to M are information representing each of post destination media designated by the users identified with the user IDs.

The content DB 22 stores content IDs and content data. The content IDs are information for identifying content. The content data is data of content identified with the content IDs.

The advertisement DB 23 stores advertisement IDs, URIs, advertiser IDs, and keywords. The advertisement IDs are information for identifying advertisement pages. A URI represents a location of the advertisement pages identified with the advertisement IDs on the network. The advertiser IDs are information for identifying advertisers of the advertisement pages identified with the advertisement IDs. The keywords are words that relate to the advertisement pages identified with the advertisement IDs.

The affiliate content DB 24 stores affiliate content IDs, a first-order user ID to an N-th-order (the value of N is an arbitrary integer equal to or greater than 2) user ID, content IDs, and advertisement IDs. The affiliate content IDs are information for identifying affiliate content. The first-order user ID among the first-order user ID to the N-th-order user ID is information for identifying the first-order user who has generated content that serves as a source of affiliate content identified with the affiliate content IDs. The second-order user ID to the N-th-order user ID of the first-order user to the N-th-order user are information for identifying users who have reused the affiliate content identified with the affiliate content IDs. In the affiliate content DB, the upper limit of the number of user IDs that can be registered is set in advance.

The user guidance information DB 25 stores user guidance time information, and affiliate content IDs. The user guidance time information is information of times at which affiliate content identified with the affiliate content IDs guides users to the advertisement pages.

The user DB 21, the content DB 22, the advertisement DB 23, the affiliate content DB 24, and the user guidance information DB 25 are associated with one another under predetermined IDs. The association is indicated by solid lines drawn from one DB to another DB among the user DB 21, the content DB 22, the advertisement DB 23, the affiliate content DB 24, and the user guidance information DB 25 in FIG. 4.

To be specific, when a user is registered as a k^{th}-order (the value of k is any integer from 1 to N) user, the user ID of the user registered in the user DB 21 is associated with the k^{th}-order user ID of the affiliate content DB 24.

In this case, since content that is uploaded or reused by the user is affiliate content, the content ID of the uploaded or reused content of the content DB 22 is associated with that of the affiliate content DB 24.

Furthermore, since an advertisement page is associated with the affiliate content, the advertisement ID of the associated advertisement page of the advertisement DB 23 is associated with that of the affiliate content DB 24.

In addition, since a user guidance time (number of times) is recorded in the user guidance information DB 25 when a user is guided to the advertisement page from the affiliate content, the affiliate content ID of the affiliate content that has guided the user of the affiliate content DB 24 is associated with that of the user guidance information DB 25.

[Hardware Configuration Example of a user terminal]

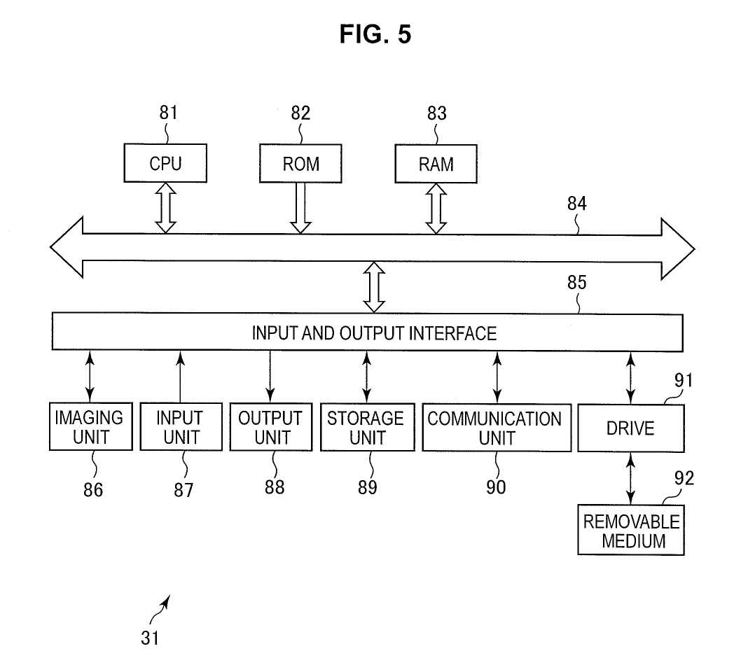

FIG. 5 is a block diagram showing a configuration example of a user terminal 31.

The user terminal 31 includes a CPU 81, a ROM 82, a RAM 83, a bus 84, an input and output interface 85, an imaging unit 86, an input unit 87, an output unit 88, a storage unit 89, a communication unit 90, a drive 91, and a removable medium 92.

The user terminal 31 has basically the same functions and configuration as the server 11 of FIG. 3. Overlapping description thereof will not be repeated.

The imaging unit 86 images subjects and outputs data of images. The imaging unit 86 has an image sensor, for example, a CCD (Charge Coupled Device), a CMOS (Complementary Metal Oxide Semiconductor), or the like to image subjects and outputs data of captured images.

Hereinabove, the hardware configurations of the server 11 and the user terminal 31 have been described. Hereinbelow, each of functional configurations of the server 11 and the user terminal 31 will be described.

### [Functional Configuration Example of the Server]

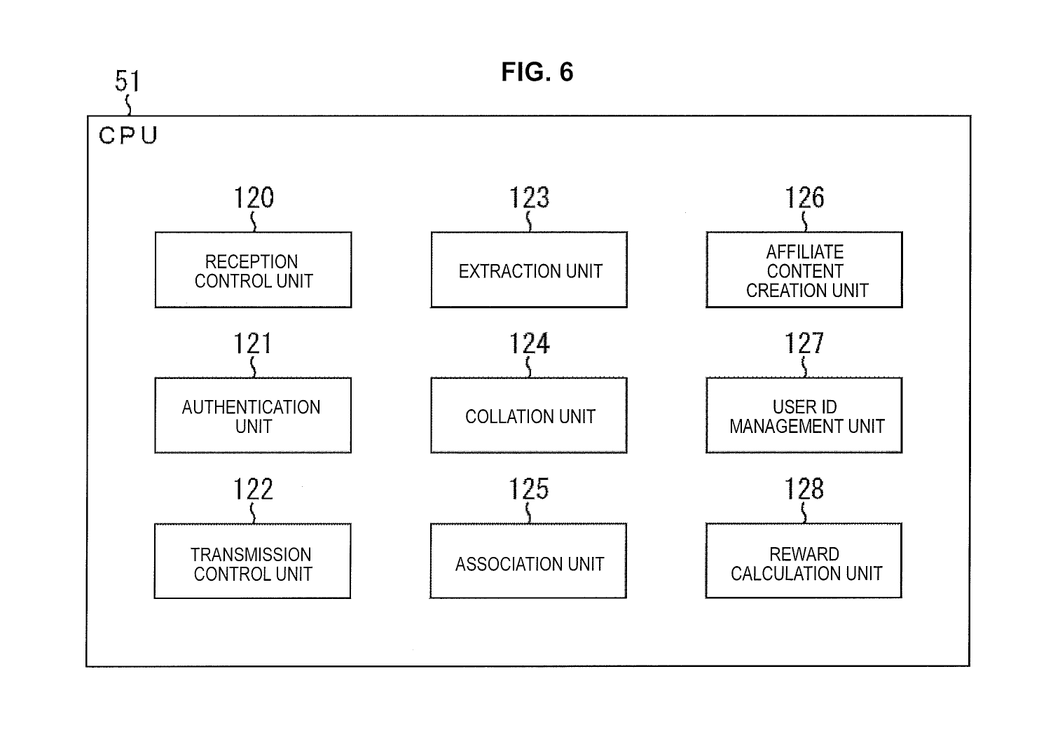

FIG. 6 is a block diagram showing a functional configuration example of the CPU 51 of the server 11 shown in FIG. 3.

The CPU 51 has a reception control unit 120, an authentication unit 121, a transmission control unit 122, an extraction unit 123, a collation unit 124, an association unit 125, an affiliate content creation unit 126, a user ID management unit 127, and a reward calculation unit 128.

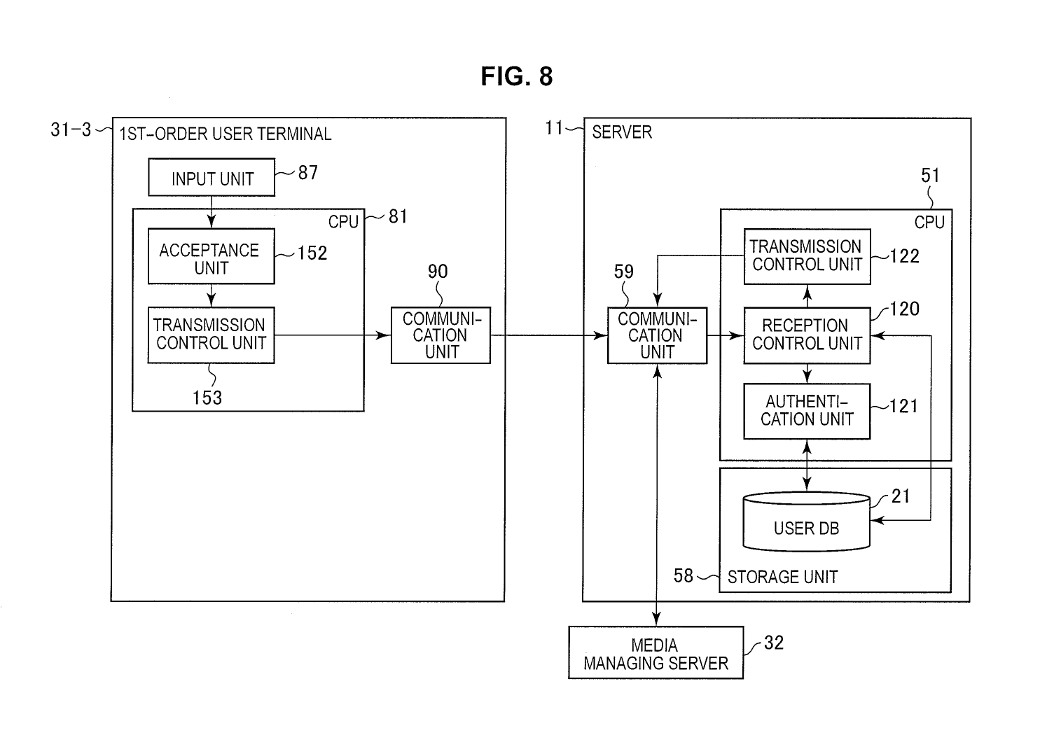

Note that details of functions of the reception control unit 120 and reward calculation unit 128 will be described later with reference to FIGS. 8 to 18.

[Functional Configuration Example of the user Terminal]

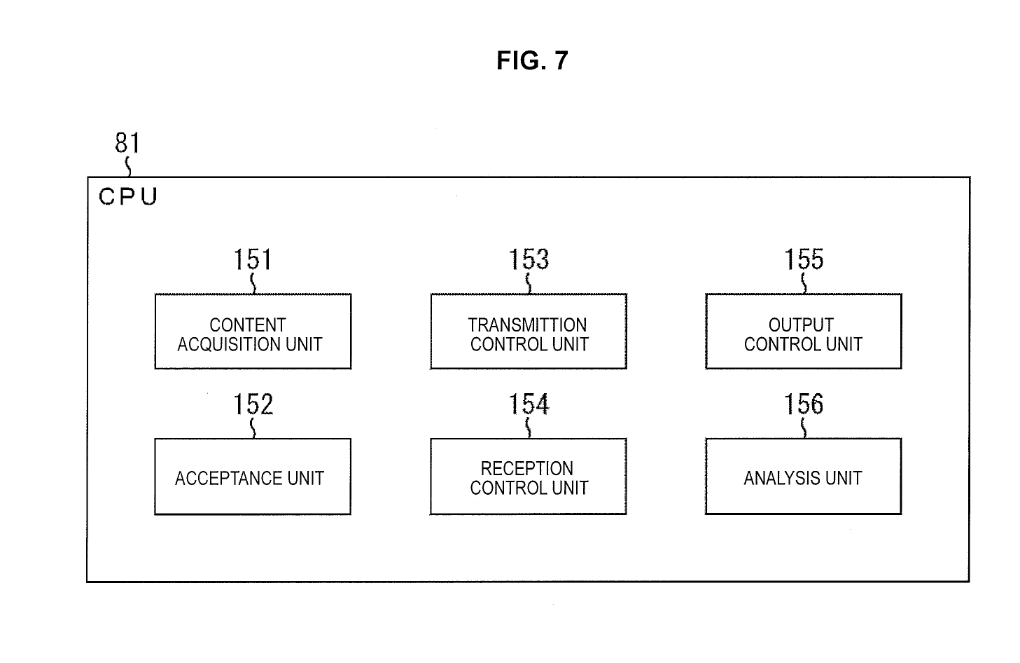

FIG. 7 is a block diagram showing a functional configuration example of the CPU 81 of the user terminal 31 shown in FIG. 5.

The CPU 81 has a content acquisition unit 151, an acceptance unit 152, a transmission control unit 153, a reception control unit 154, an output control unit 155, and an analysis unit 156.

Note that details of functions of the content acquisition unit 151 and analysis unit 156 will be described later with reference to FIGS. 8 to 18.

[First-Order user Registration Process]

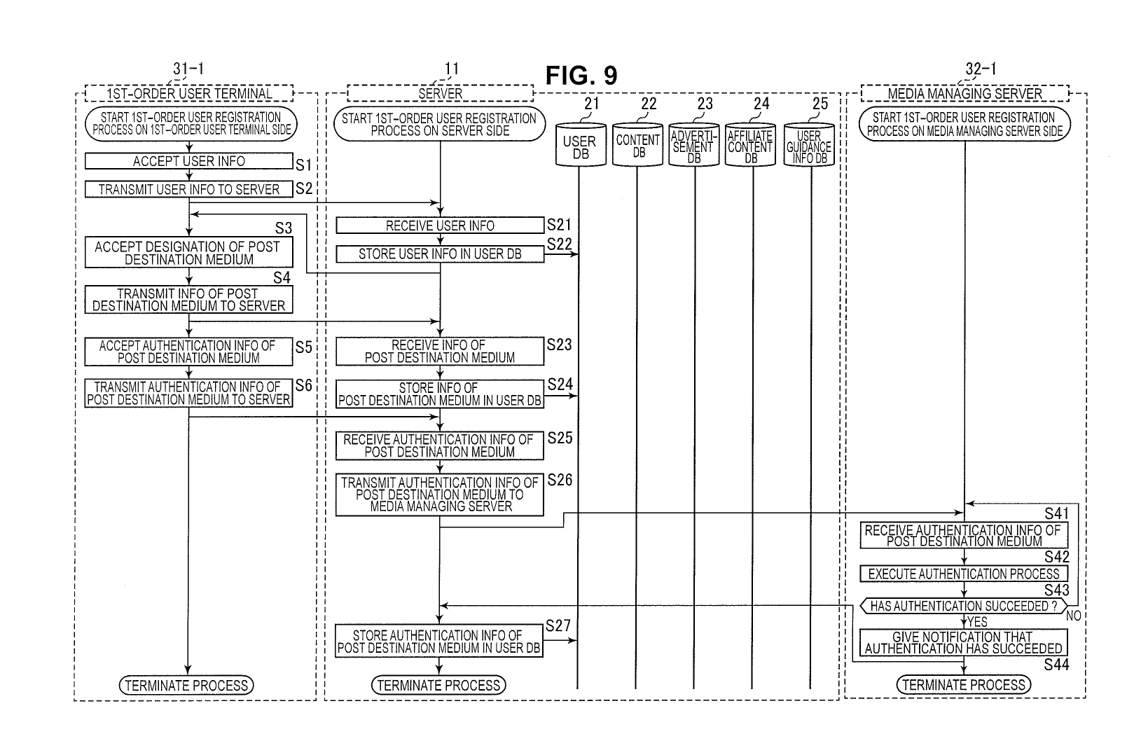

Hereinbelow, a first-order user registration process that is a series of processes performed in the information processing system 1 to register the first-order user as a user will be described with reference to FIGS. 8 and 9.

[Functional Configuration Example of the Server and the user Terminal when the First-Order user Registration Process is Executed]

FIG. 8 is a block diagram showing a functional configuration example among functions in each of the CPU 51 of the server 11 shown in FIG. 3 and the CPU 81 of the user terminal 31 shown in FIG. 5 for realizing the first-order user registration process.

When the first-order user registration process is executed, the acceptance unit 152 and the transmission control unit 153 function in the CPU 81 of the first-order user terminal 31-1 as shown in FIG. 8.

In the CPU 51 of the server 11, the reception control unit 120, the authentication unit 121, and the transmission control unit 122 function when the first-order user registration process is executed as shown in FIG. 8.

Next, the flow of the first-order user registration process will be described with reference to FIG. 9, and the details of each of the functional blocks shown in FIG. 8 will also be described herein.

[Flow of the First-Order user Registration Process]

FIG. 9 is a flowchart describing the flow of the first-order user registration process. From the left side of FIG. 9, a flowchart describing the flow of the first-order user registration process performed on the first-order user terminal 31-1 side, a flowchart describing the flow of the first-order user registration process performed on the server 11 side, and a flowchart describing the flow of the first-order user registration process performed on the media managing server 32-1 side are shown in this order. Note that the arrows pointing right and left and connecting the three flowcharts in FIG. 9 represent flows of information.

In Step S1, the acceptance unit 152 of the first-order user terminal 31-1 accepts user information input through a manipulation performed on the input unit 87 by the first-order user. The user information includes information for logging in to the information processing system 1, specifically, the user ID and password.

In Step S2, the transmission control unit 153 transmits the user information to the server 11. Note that transmission and reception of information with the server 11 is performed when the transmission control unit 153 controls the communication unit 90 or the reception control unit 154 controls the communication unit 90.

In Step S21, the reception control unit 120 of the server 11 receives the user information transmitted from the first-order user terminal 31-1. Note that transmission and reception of information with the first-order user terminal 31-1 is performed when the reception control unit 120 controls the communication unit 59 or the transmission control unit 122 controls the communication unit 59.

In Step S22, the authentication unit 121 registers the first-order user as a user by storing the received user information in the user DB 21. Note that, hereinbelow, the ID of the registered first-order user is called the first-order user ID.

Accordingly, the log-in process of the first-order user terminal 31-1 is terminated in the server 11, and a notification of this termination is transmitted to the first-order user terminal 31-1.

In Step S3, the acceptance unit 152 of the first-order user terminal 31-1 accepts designation of a post destination medium input through a manipulation performed on the input unit 87 by the first-order user.

In Step S4, the transmission control unit 153 transmits information of the post destination medium for which the acceptance unit 152 has accepted the designation to the server 11.

In Step S23, the reception control unit 120 of the server 11 receives the information of the post destination medium transmitted from the first-order user terminal 31-1.

In Step S24, the reception control unit 120 stores the information of the post destination medium in the user DB 21 by associating it with the user information stored in the process of Step S22.

In Step S5, the acceptance unit 152 of the first-order user terminal 31-1 accepts authentication information of the post destination medium input through a manipulation performed on the input unit 87 by the first-order user.

In Step S6, the transmission control unit 153 transmits the authentication information of the post destination medium to the server 11.

Accordingly, the first-order user registration process on the first-order user terminal 31-1 side is terminated.

In Step S25, the reception control unit 120 of the server 11 receives the authentication information of the post destination medium transmitted from the first-order user terminal 31-1.

In Step S26, the transmission control unit 122 transmits the authentication information of the post destination medium to the media managing server 32-1.

In Step S41, the media managing server 32-1 receives the authentication information of the post destination medium transmitted from the server 11.

In Step S42, the media managing server 32-1 executes an authentication process based on the authentication information.

In Step S43, the media managing server 32-1 determines whether or not the authentication has succeeded.

When the authentication is determined not to have succeeded in Step S43, the process returns to Step S41, and the process and the following process are repeated. In other words, the loop process of Steps S41 to S43 is repeated until the authentication succeeds. Note that, when the authentication has not succeeded, the media managing server 32-1 transmits a notification that the authentication has not succeeded to the server 11. Then, the server 11 transmits the notification that the authentication has not succeeded to the user terminal 31-1. When receiving the notification transmitted from the server 11, the user terminal 31-1 returns to the process of Step S5. In other words, the user terminal 31-1 repeats the processes of Steps S5 and S6 and the server 11 repeats the processes of Steps S25 and 26 until the authentication succeeds.

On the other hand, when the authentication is determined to have succeeded in Step S43, the process proceeds to Step S44. For example, when the authentication information such as a password transmitted from the server 11 coincides with authentication information registered in the media managing server 32-1 in advance, the authentication succeeds.

In Step S44, the media managing server 32-1 transmits a notification that the authentication has succeeded to the server 11.

Accordingly, the first-order user registration process on the media managing server 32-1 side is terminated.

When the reception control unit 120 of the server 11 receives the notification transmitted from the media managing server 32-1, the process proceeds to Step S27.

In Step S27, the reception control unit 120 of the server 11 stores the authentication information of the post destination medium in the user DB 21 in association with the user information stored in the process of Step S22 and the information of the post destination medium stored in the process of Step S24.

Accordingly, the first-order user registration process on the server 11 side is terminated.

As described above, in the first-order user registration process, the first-order user designates the post destination medium in advance. Accordingly, the first-order user can be spared the effort of designating a medium in which content is displayed when he or she contributes the content.

[Second-Order user Registration Process]

Next, a second-order user registration process that is a series of processes performed in the information processing system 1 to register the second-order user as a user will be described.

Note that a functional configuration of the functions in the server 11 and the user terminal 31 for realizing the second-order user registration process is the same as that for realizing the executional function of the first-order user registration process shown in FIG. 8. Thus, repetitive description thereof will be omitted.

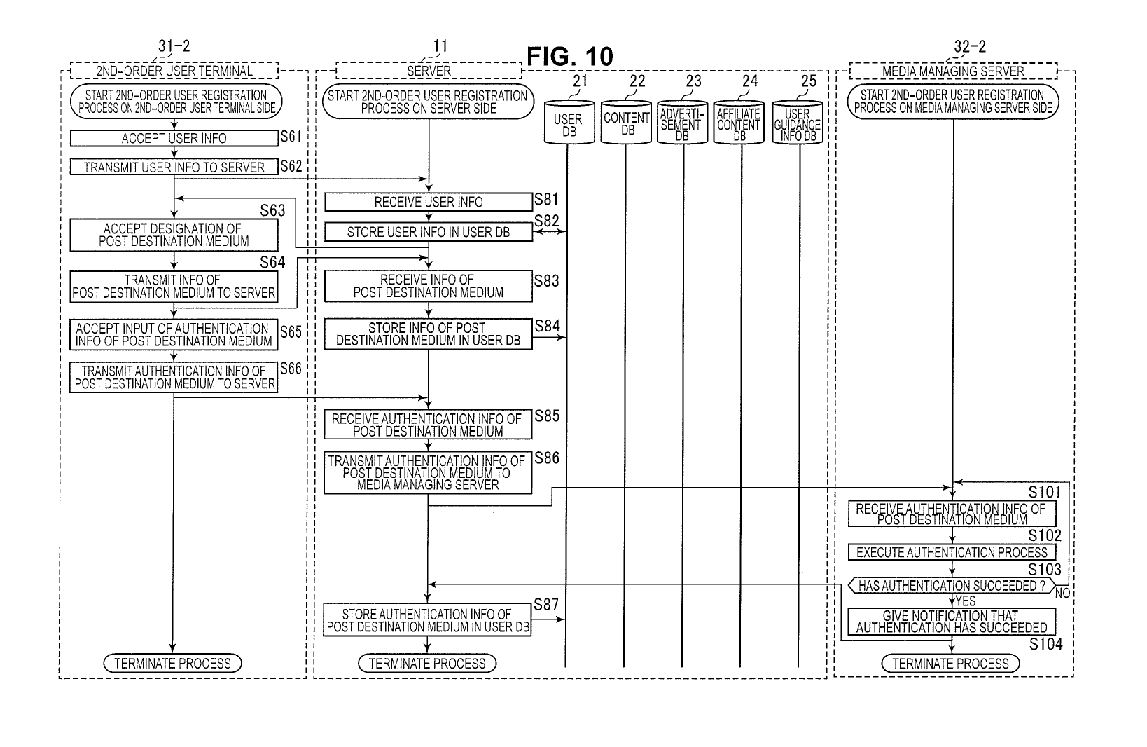

FIG. 10 is a flowchart describing the flow of the second-order user registration process. From the left side of FIG. 10, a flowchart describing the flow of the second-order user registration process performed on the second-order user terminal 31-2 side, a flowchart describing the flow of the second-order user registration process performed on the server 11 side, and a flowchart describing the flow of the second-order user registration process performed on the media managing server 32-2 side are shown in this order. Note that the arrows pointing right and left and connecting the three flowcharts in FIG. 10 represent flows of information.

Note that each of the second-order user registration processes performed on the second-order user terminal 31-2 side, the server 11 side, and the media managing server 32-2 side is the same as each of the first-order user registration processes of FIG. 9 performed on the first-order user terminal 31-1 side, the server 11 side, and the media managing server 32-1 side. To be specific, the processes of Steps S1 to S6 of FIG. 9 correspond to the processes of Steps S61 to S66 of FIG. 10. In addition, the processes of Steps S21 to S27 of FIG. 9 correspond to the processes of Steps S81 to S87 of FIG. 10. In addition, the processes of Steps S41 to S44 of FIG. 9 correspond to the processes of Steps S101 to S104 of FIG. 10. As a result of the second-order user registration process of FIG. 10, information of the second-order user is stored in the user DB 21 of the server 11. Note that, in FIG. 10, the ID of the second-order user registered in the process of Step S82 is called the second-order user ID.

As shown in FIG. 10, in the second-order user registration process, the second-order user who reuses affiliate content also designates a post destination medium in advance. Thus, the second-order user also can be spared the effort of designating a medium in which content is displayed when he or she contributes the content.

### [First-Order Registration Process of Content]

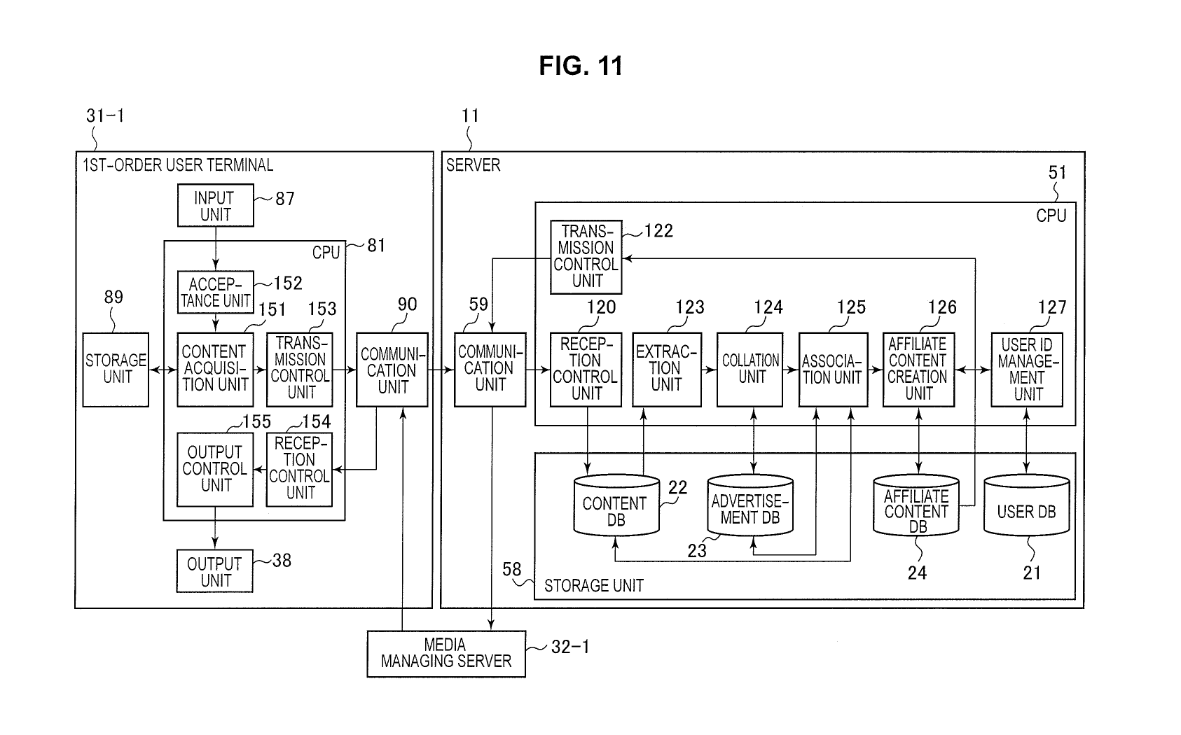

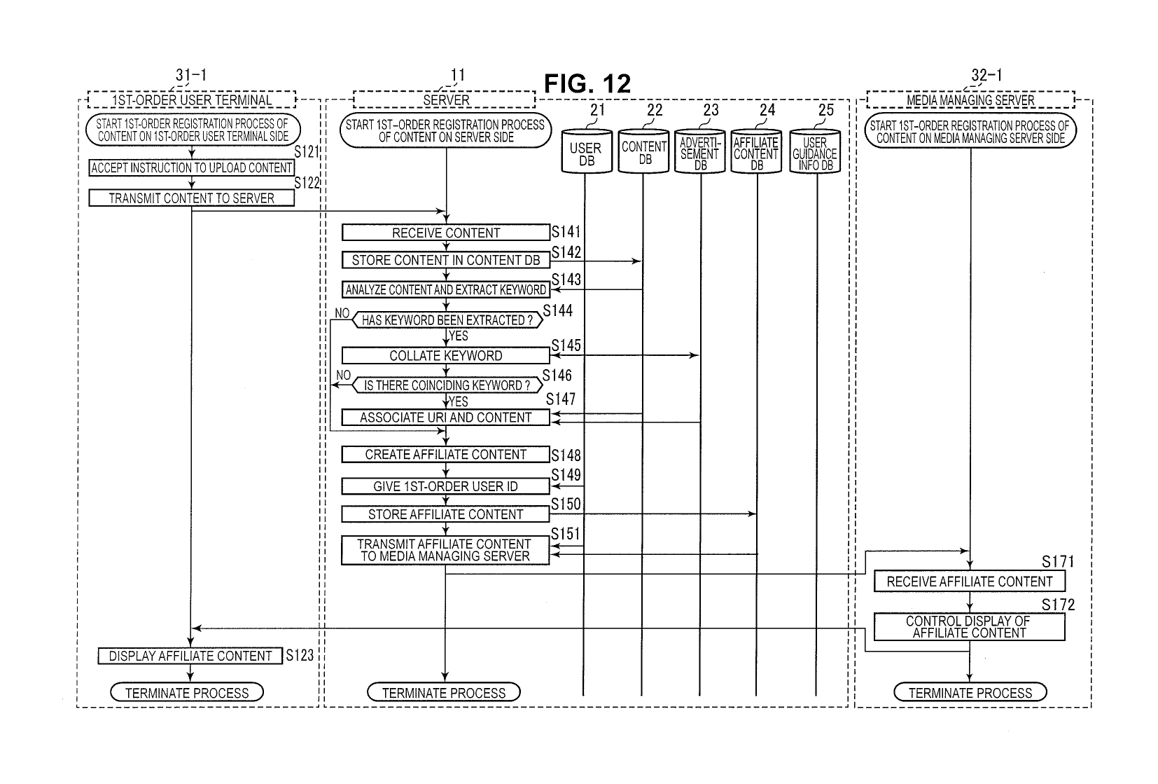

Next, with reference to FIGS. 11 and 12, a first-order registration process of content that is a series of processes performed in the information processing system 1 to register content when the first-order user registers the content he or she has generated in the server 11 (hereinafter referred to as first-order registration) will be described.

[Functional Configuration Example of the Server and the user Terminal when the First-Order Registration Process of Content is Executed]

FIG. 11 is a block diagram showing a functional configuration example among functions in each of the CPU 51 of the server 11 shown in FIG. 3 and the CPU 81 of the user terminal 31 shown in FIG. 5 for realizing the first-order registration process of content.

When the first-order registration process of content is executed, the content acquisition unit 151, the acceptance unit 152, the transmission control unit 153, the reception control unit 154, and the output control unit 155 function in the CPU 81 of the first-order user terminal 31-1 of the first-order user as shown in FIG. 11.

In the CPU 51 of the server 11, the reception control unit 120, the transmission control unit 122, the extraction unit 123, the collation unit 124, the association unit 125, the affiliate content creation unit 126, and the user ID management unit 127 function when the first-order user registration process is executed as shown in FIG. 11.

Note that, in order to simplify illustration, arrows indicating association of the DBs are omitted, but in reality, the association is formed as shown in FIG. 4.

Next, with reference to FIG. 12, the flow of the first-order registration process of content will be described, and details of the functional blocks shown in FIG. 11 will also be described herein.

### [Flow of the First-Order Registration Process of Content]

FIG. 12 is a flowchart describing the flow of the first-order registration process of content. From the left side of FIG. 12, a flowchart describing the flow of the first-order registration process of content performed on the first-order user terminal 31-1 side, a flowchart describing the flow of the first-order registration process of content performed on the server 11 side, and a flowchart describing the flow of the first-order registration process of content performed on the media managing server 32-1 side are shown in this order. Note that the arrows pointing right and left and connecting the three flowcharts in FIG. 12 represent flows of information.

In Step S121, the acceptance unit 152 of the first-order user terminal 31-1 accepts an instruction to upload content input through a manipulation performed on the input unit 87 by the first-order user.

Then, the content acquisition unit 151 acquires content data stored in the storage unit 89. Note that the content data stored in the storage unit 89 is UGC generated by the first-order user.

In Step S122, the transmission control unit 153 transmits the content acquired by the content acquisition unit 151 to the server 11.

In Step S141, the reception control unit 120 of the server 11 receives the content transmitted from the first-order user terminal 31-1.

In Step S142, the reception control unit 120 gives a content ID to the received content and then stores the content in the content DB 22.

In Step S143, the extraction unit 123 analyzes the substance of the content stored in the content DB 22 and then extracts a keyword.

In Step S144, the extraction unit 123 determines whether or not a keyword has been extracted.

When a keyword is determined to have been extracted in Step S144, the process proceeds to Step S145.

In Step S145, the collation unit 124 collates the keyword. In other words, the collation unit 124 compares the extracted keyword to keywords that relate to the advertisement page stored in the advertisement DB 23.

In Step S146, the collation unit 124 determines whether or not there is a coinciding keyword.

When a coinciding keyword is determined to be present in Step S146, in other words, when the comparison result is that the extracted keyword coincides with a keyword that relates to the advertisement page, the process proceeds to Step S147.

In Step S147, the association unit 125 associates the URI of the advertisement page and the content.

In Step S148, the affiliate content creation unit 126 creates the content associated with the URI of the advertisement page in Step S147 as affiliate content.

In this case, the created affiliate content is associated with the advertisement ID of the advertisement page.

On the other hand, when no keyword is determined to have been extracted in Step S144, and when no coinciding keyword is determined to be present in Step S146, the process proceeds to Step S148. When the process proceeds to Step S148 after the answer is determined to be NO in Step S144 or Step S146, there is no URI of the advertisement page to be associated with the content. In Step S148 in such a case, the affiliate content creation unit 126 creates content that is not associated with the URI of the advertisement page as affiliate content. In this case, the created affiliate content is not associated with the advertisement ID of the advertisement page.

The reason for creating content that is not associated with the URI of the advertisement page as affiliate content as described above is as follows. That is, since affiliate content is associated with each of the user IDs of at least first-to N-th-order users, it is possible to ascertain the degree of propagation and duplication of the affiliate content, in other words, how many users are sharing and reusing the affiliate content. In order to facilitate such ascertainment, content that is not associated with the URI of the advertisement page is created as affiliate content.

In Step S149, the user ID management unit 127 gives the first-order user ID stored in the user DB 21 to the created affiliate content.

In Step S150, the affiliate content creation unit 126 gives an affiliate content ID to the affiliate content to which the first-order user ID has been given and then stores the affiliate content in the affiliate content DB 24. Accordingly, the affiliate content DB 24 stores the affiliate content ID, the first-order user ID, the content ID, and the advertisement ID.

In Step S151, the transmission control unit 122 transmits the affiliate content to the media managing server 32-1 that manages the post destination medium designated by the first-order user in advance.

Accordingly, the first-order registration process of content performed on the server 11 side is terminated.

In Step S171, the media managing server 32-1 receives the affiliate content transmitted from the server 11.

In Step S172, the media managing server 32-1 controls display of the affiliate content in the first-order user terminal 31-1 by transmitting various kinds of data and various kinds of control information to the first-order user terminal 31-1.

Accordingly, the first-order registration process of content performed on the media managing server 32-1 side is terminated.

The reception control unit 154 of the first-order user terminal 31-1 receives the various kinds of data and various kinds of control information transmitted from the media managing server 32-1, and the process proceeds to Step S123.

In Step S123, the output control unit 155 causes the affiliate content to be displayed in the output unit 88 based on the various kinds of data and various kinds of control information transmitted from the media managing server 32-1.

Accordingly, the first-order registration process of content performed on the first-order user terminal 31-1 side is terminated.

Note that the processes of Steps S143 to S147 of FIG. 12 may be executed independently of the first-order registration process of content. For example, when an advertisement associated with content is reviewed after the first-order registration process of the content, the processes of Steps S143 to S147 of FIG. 12 are independently executed to associate the URI of a new advertisement page with the content.

### [Reuse Process]

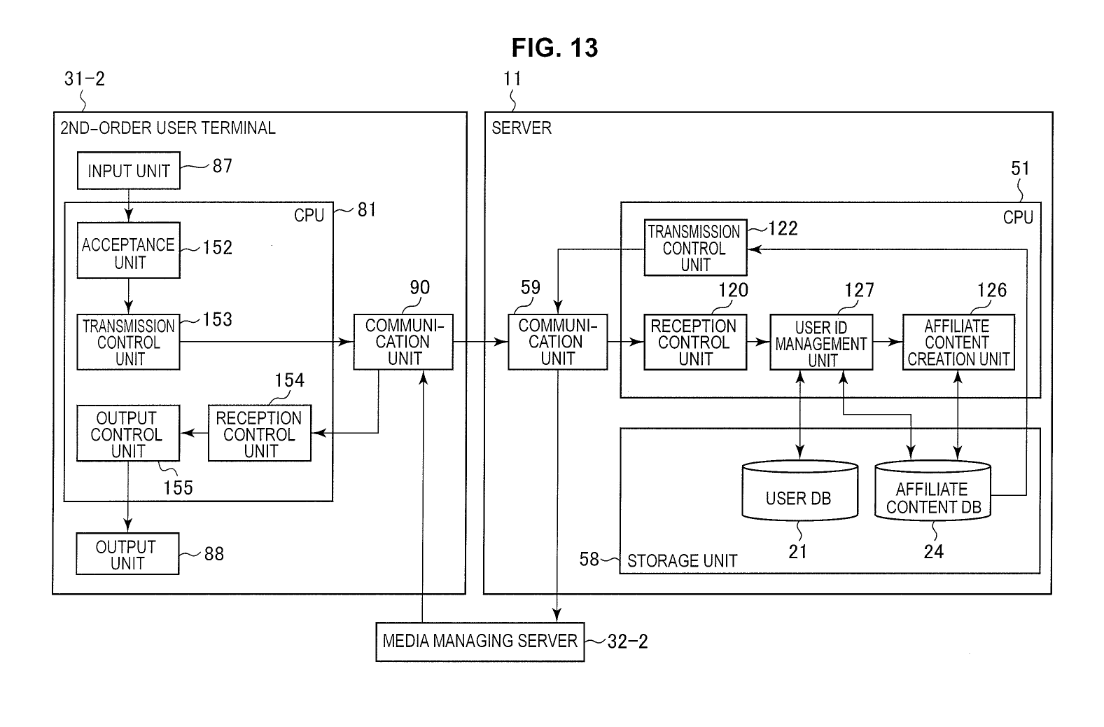

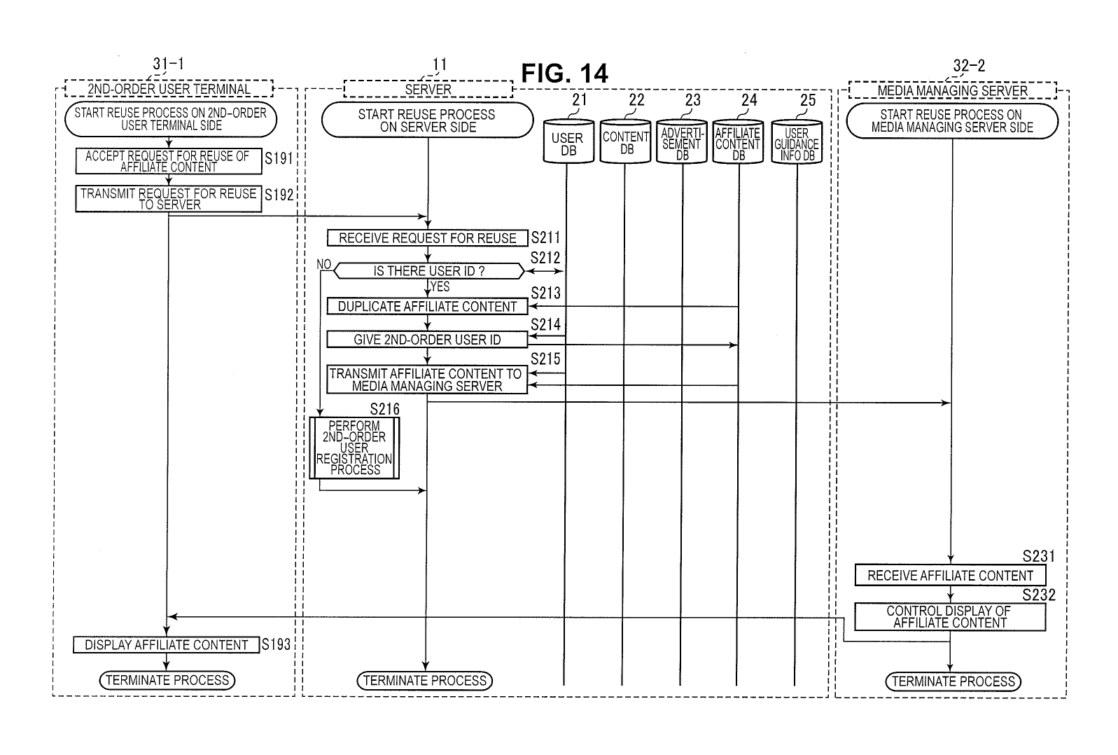

Next, with reference to FIGS. 13 and 14, a reuse process that is a series of processes executed in the information processing system 1 when the second-order user reuses affiliate content will be described.

[Functional Configuration Example of the Server and the user Terminal when the Reuse Process is Executed]

FIG. 13 is a block diagram showing a functional configuration example among functions in each of the CPU 51 of the server 11 shown in FIG. 3 and the CPU 81 of the user terminal 31 shown in FIG. 5 for realizing the reuse process.

When the reuse process is executed, the acceptance unit 152, the transmission control unit 153, the reception control unit 154, and the output control unit 155 function in the CPU 81 of the second-order user terminal 31-2 of the second-order user as shown in FIG. 13.

In the CPU 51 of the server 11, the reception control unit 120, the transmission control unit 122, the affiliate content creation unit 126, and the user ID management unit 127 function when the reuse process is executed as shown in FIG. 13.

Note that, in order to simplify illustration, arrows indicating association of the DBs are omitted, but in reality, the association is formed as shown in FIG. 4.

Next, with reference to FIG. 14, the flow of the reuse process will be described, and details of the functional blocks shown in FIG. 13 will also be described herein.

### [Flow of the Reuse Process]

FIG. 14 is a flowchart describing the flow of the reuse process. From the left side of FIG. 14, a flowchart describing the flow of the reuse process performed on the second-order user terminal 31-2 side, a flowchart describing the flow of the reuse process performed on the server 11 side, and a flowchart describing the flow of the reuse process performed on the media managing server 32-2 side are shown in this order. Note that the arrows pointing right and left and connecting the three flowcharts in FIG. 14 represent flows of information.

In Step S191, the acceptance unit 152 of the second-order user terminal 31-2 accepts a request for a reuse of affiliate content input through a manipulation performed on the input unit 87 by the second-order user. In other words, the second-order user inputs the request for the reuse of the affiliate content through a predetermined manipulation performed on the input unit 87 using the second-order user terminal 31-2 during or after display of the affiliate content via the post destination medium designated by the first-order user.

In Step S192, the transmission control unit 153 transmits the request for the reuse of the affiliate content to the server 11.

In Step S211, the reception control unit 120 of the server 11 receives the request for the reuse transmitted from the second-order user terminal 31-2.

In Step S212, the user ID management unit 127 determines whether or not there is the user ID of the second-order user (that is, the second-order user ID) of the second-order user terminal 31-2 in the user DB 21. In other words, it is determined whether or not there is the second-order user ID in the user DB 21 and the post destination medium is designated.

When the second-order user ID is determined not to be present in the user DB 21 in Step S212, the process proceeds to Step S216.

In Step S216, the server 11 executes the second-order user registration process of FIG. 10. In FIG. 14, in order to simplify illustration, the second-order user registration process is described only with respect to the server 11, but as is obvious from FIG. 10, the second-order user registration process is executed not only by the server 11 but also in cooperation with the second-order user terminal 31-2 and the media managing server 32-2.

On the other hand, when the second-order user ID is determined to be present in the user DB 21 in Step S212, the process proceeds to Step S213. Note that, when there is the second-order user ID in the user DB 21, the post destination medium of affiliate content of which a reuse has been requested is designated.

In Step S213, the affiliate content creation unit 126 duplicates the affiliate content stored in the affiliate content DB 24 of which the reuse has been requested.

In Step S214, the user ID management unit 127 gives the second-order user ID stored in the user DB 21 to the duplicated affiliate content.

In Step S215, the transmission control unit 122 transmits the affiliate content to which the second-order user ID has been given to the media managing server 32-2 that manages the post destination medium designated by the second-order user in advance.

Accordingly, the reuse process performed on the server 11 side is terminated.

In Step S231, the media managing server 32-2 receives the affiliate content transmitted from the server 11.

In Step S232, the media managing server 32-2 controls display of the affiliate content in the second-order user terminal 31-2 by transmitting various kinds of data and various kinds of control information to the second-order user terminal 31-2.

Accordingly, the reuse process performed on the media managing server 32-2 side is terminated.

When the reception control unit 154 of the second-order user terminal 31-2 receives the various kinds of data and various kinds of control information transmitted from the media managing server 32-2, the process proceeds to Step S193.

In Step S193, the output control unit 155 causes the affiliate content to be displayed in the output unit 88 based on the various kinds of data and various kinds of control information from the media managing server 32-2.

Accordingly, the reuse process performed on the second-order user terminal 31-2 side is terminated.

### [Advertisement Page Display Process]

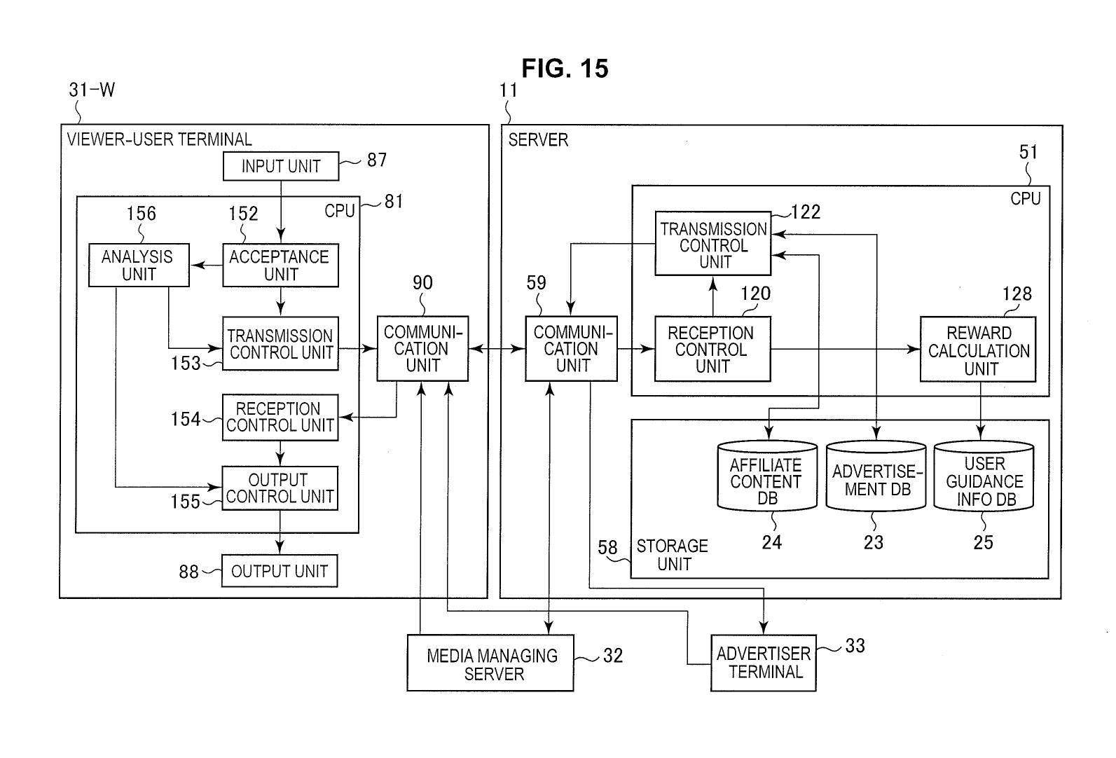

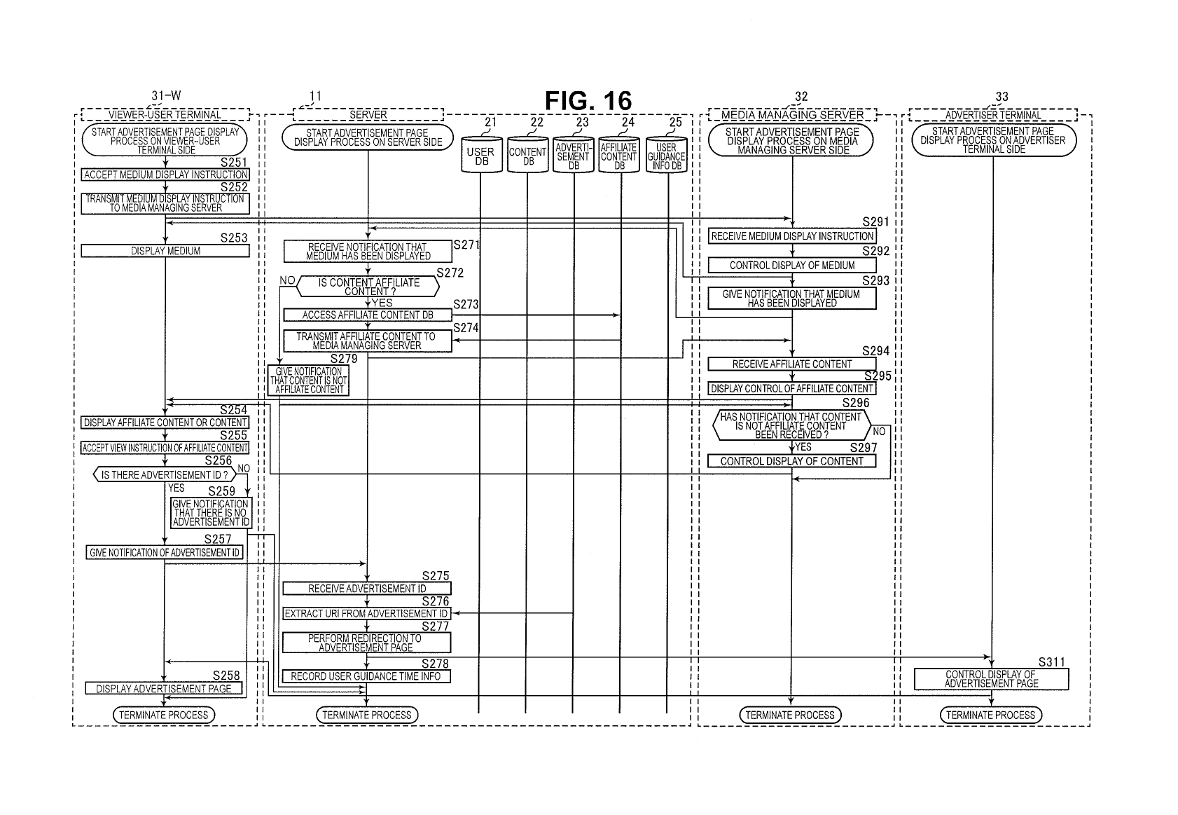

Next, with reference to FIGS. 15 and 16, an advertisement page display process that is a series of processes performed in the information processing system 1 to display an advertisement page will be described.

[Functional Configuration Example of the Server and the user Terminal when the Advertisement Page Display Process is Executed]

FIG. 15 is a block diagram showing a functional configuration example among functions in each of the CPU 51 of the server 11 shown in FIG. 3 and the CPU 81 of the user terminal 31 shown in FIG. 5 for realizing the advertisement page display process.

When the advertisement page display process is executed, the acceptance unit 152, the transmission control unit 153, the reception control unit 154, the output control unit 155, and the analysis unit 156 function in the CPU 81 of a viewer-user terminal 31-W (the value of W is any integer from 1 to N) as shown in FIG. 15.

In the CPU 51 of the server 11, the reception control unit 120, the transmission control unit 122, and the reward calculation unit 128 function when the advertisement page display process is executed as shown in FIG. 15.

Note that, in order to simplify illustration, arrows indicating association of the DBs are omitted, but in reality, the association is formed as shown in FIG. 4.

Next, with reference to FIG. 16, the flow of the advertisement page display process will be described, and details of the functional blocks shown in FIG. 15 will also be described herein.

### [Flow of the Advertisement Page Display Process]

FIG. 16 is a flowchart describing the flow of the advertisement page display process. From the left side of FIG. 16, a flowchart describing the flow of the advertisement page display process performed on the viewer-user terminal 31-W side, a flowchart describing the flow of the advertisement page display process performed on the server 11 side, a flowchart describing the flow of the advertisement page display process performed on the media managing server 32 side, and a flowchart with regard to the flow of the advertisement page display process performed on the advertiser terminal 33 side are shown in this order. Note that the arrows pointing right and left and connecting the four flowcharts in FIG. 16 represent flows of information.

In Step S251, the acceptance unit 152 of the viewer-user terminal 31-W accepts a medium display instruction input through a manipulation performed on the input unit 87 by the viewer-user.

In Step S252, the transmission control unit 153 transmits the medium display instruction to the media managing server 32.

In Step S291, the media managing server 32 receives the medium display instruction transmitted from the viewer-user terminal 31-W.

In Step S292, the media managing server 32 controls display of the medium in the viewer-user terminal 31-W by transmitting various kinds of data and various kinds of control information to the viewer-user terminal 31-W.

When the reception control unit 154 of the viewer-user terminal 31-W receives the various kinds of data and various kinds of control information transmitted from the media managing server 32, the process proceeds to Step S253.

In Step S253, the output control unit 155 causes the medium to be displayed in the output unit 88 based on the various kinds of data and various kinds of control information from the media managing server 32.

When the medium is displayed, the process proceeds to Step S254. Note that the process of Step S254 and succeeding processes will be described later.

In Step S293, the media managing server 32 transmits a notification that the medium has been displayed on the viewer-user terminal 31-W to the server 11.

In Step S271, the reception control unit 120 of the server 11 receives the notification transmitted from the media managing server 32.

In Step S272, the transmission control unit 122 determines whether or not content included in the medium displayed in the viewer-user terminal 31-W is affiliate content. For example, the transmission control unit 122 analyzes whether or not an affiliate content ID has been given to the content included in the medium, and when it has been given, the content is determined to be affiliate content.

When the content included in the medium displayed on the viewer-user terminal 31-W is determined to be affiliate content in Step S272, the process proceeds to Step S273.

In Step S273, the transmission control unit 122 accesses the affiliate content DB 24 to acquire the affiliate content. At this moment, when the advertisement ID of the advertisement page has been associated with the affiliate content in the process of Step S148 of FIG. 12, the transmission control unit 122 also acquires the associated advertisement ID.

In Step S274, the transmission control unit 122 transmits the acquired affiliate content to the media managing server 32. At this moment, when the advertisement ID has been acquired in the process of Step S273, the transmission control unit 122 gives the acquired advertisement ID to the affiliate content and then transmits the affiliate content.

In Step S294, the media managing server 32 receives the affiliate content transmitted from the server 11.

In Step S295, the media managing server 32 controls display of the affiliate content in the viewer-user terminal 31-W by transmitting various kinds of data and various kinds of control information to the viewer-user terminal 31-W. Note that the process of Step S296 and succeeding processes will be described later.

When the reception control unit 154 of the viewer-user terminal 31-W receives the various kinds of data and various kinds of control information from the media managing server 32-1, the process proceeds to Step S254. Note that the process of Step S254 and succeeding processes will be described later.

On the other hand, when the content included in the medium displayed in the viewer-user terminal 31-W is determined not to be the affiliate content in the determination process of Step S272, the process proceeds to Step S279.

In Step S279, the transmission control unit 122 transmits a notification that the content is not the affiliate content to the media managing server 32. Accordingly, the advertisement page display process performed on the server 11 side is terminated.

In Step S296, the media managing server 32 determines whether or not the notification that the content is not the affiliate content has been received from the server 11.

When the notification that the content is not the affiliate content is determined to have been received from the server 11 in Step S296, the process proceeds to Step S297.

In Step S297, the media managing server 32 controls display of the content in the viewer-user terminal 31-W by transmitting various kinds of data and various kinds of control information to the viewer-user terminal 31-W.

When the reception control unit 154 of the viewer-user terminal 31-W receives the various kinds of data and various kinds of control information transmitted from the media managing server 32-1, the process proceeds to Step S254. Note that the process of Step S254 and succeeding processes will be described later.

On the other hand, when the notification that the content is not the affiliate content is determined not to have been received from the server 11 in the determination process of Step S296, the advertisement page display process performed on the media managing server 32 side is terminated.

In Step S254, the output control unit 155 of the viewer-user terminal 31-W causes the affiliate content or the content to be displayed in the output unit 88 based on the various kinds of data and various kinds of control information (Steps S295 and 5297) from the media managing server 32.

In Step S255, the acceptance unit 152 accepts a view instruction of the affiliate content input through a manipulation performed on the input unit 87 by the viewer-user, for example, a manipulation of selecting (clicking or the like) the affiliate content.

In Step S256, the analysis unit 156 determines whether or not an advertisement ID has been given to the affiliate content.

When an advertisement ID is determined to have been given to the affiliate content in Step S256, the process proceeds to Step S257.

In Step S257, the transmission control unit 153 transmits the advertisement ID given to the affiliate content to the server 11.

In Step S275, the reception control unit 120 of the server 11 receives the advertisement ID of the affiliate content transmitted from the viewer-user terminal 31-W.

In Step S276, the transmission control unit 122 extracts a URI that relates to the advertisement ID received in the process of Step S275 from the advertisement DB 23.

In Step S277, the transmission control unit 122 performs redirection to an advertiser's page managed by the advertiser terminal 33 based on the extracted URI. In other words, the transmission control unit 122 performs redirection to the advertiser terminal 33 in order to execute control over display of the advertisement page associated with the affiliate content. Note that the process of Step S278 and succeeding processes will be described later.

In Step S311, after performing redirection from the server 11, the advertiser terminal 33 controls display of the advertisement page in the viewer-user terminal 31-W by transmitting various kinds of data and various kinds of control information to the viewer-user terminal 31-W.

Accordingly, the advertisement page display process performed on the advertiser terminal 33 side is terminated.

When the reception control unit 154 of the viewer-user terminal 31-W receives the various kinds of data and various kinds of control information transmitted from the advertiser terminal 33, the process proceeds to Step S258.

In Step S258, the output control unit 155 causes the advertisement page to be displayed in the output unit 88 based on the various kinds of data and various kinds of control information from the advertiser terminal 33. Accordingly, the advertisement page display process of the viewer-user terminal 31-W is terminated.

On the other hand, when no advertisement ID is determined to have been given to the affiliate content in the determination process of Step S256, the process proceeds to Step S259.

In Step S259, the transmission control unit 153 transmits a notification that no advertisement ID has been given to the server 11. In this case, when the notification that no advertisement ID has been given is received on the server 11 side, the advertisement page display process is forcedly terminated.

Accordingly, the advertisement page display process of the viewer-user terminal 31-W is terminated.

In Step S278, the reward calculation unit 128 of the server 11 records user guidance time information of the affiliate content to the user guidance information DB 25. In other words, the reward calculation unit 128 records time information at which the advertisement page was displayed based on the view instruction of the affiliate content in the user guidance information DB 25.

Accordingly, the advertisement page display process performed on the server 11 side is terminated.

### [Reward Distribution Process]

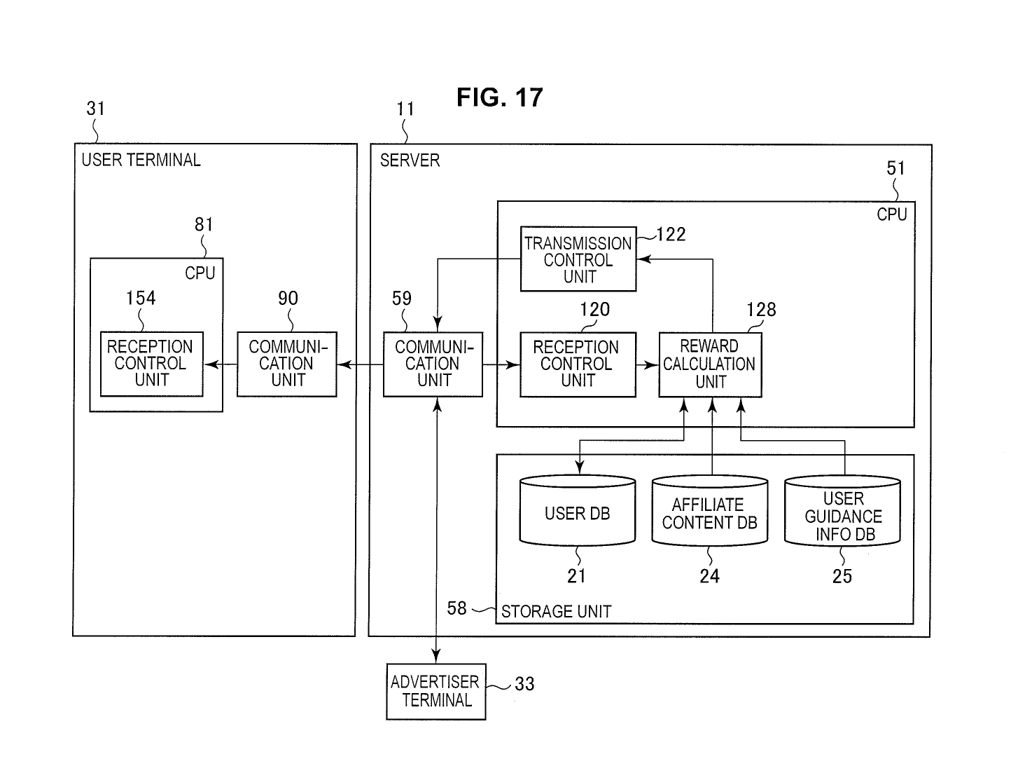

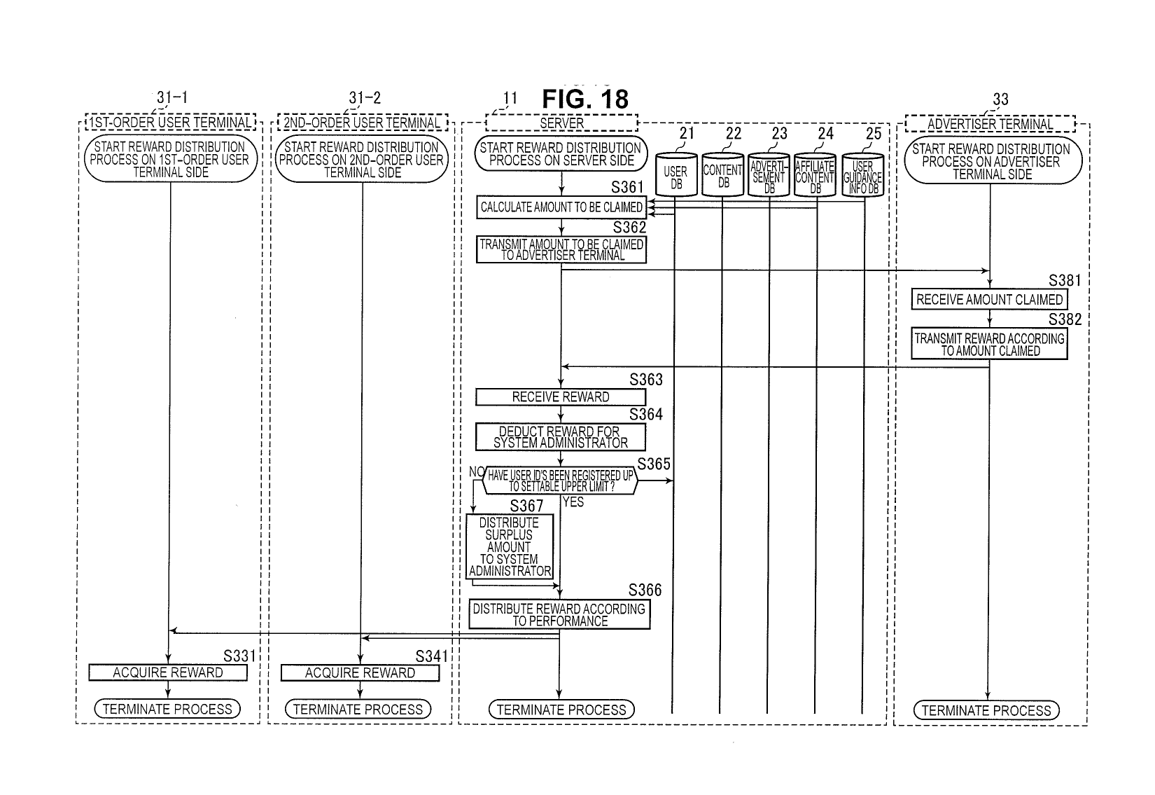

Next, with reference to FIGS. 17 and 18, a reward distribution process that is a series of processes performed in the information processing system 1 to distribute a reward will be described.

[Functional Configuration Example of the Server and the user Terminal when the Reward Distribution Process is Executed]

FIG. 17 is a block diagram showing a functional configuration example among functions in each of the CPU 51 of the server 11 shown in FIG. 3 and the CPU 81 of the user terminal 31 shown in FIG. 5 for realizing the reward distribution process.

When the reward distribution process is executed, the reception control unit 154 functions in the CPU 81 of the user terminal 31 as shown in FIG. 17.

In the CPU 51 of the server 11, the reception control unit 120, the transmission control unit 122, and the reward calculation unit 128 function when the reward distribution process is executed, as shown in FIG. 17.

Note that, in order to simplify illustration, arrows indicating association of the DBs are omitted, but in reality, the association is formed as shown in FIG. 4.

Next, with reference to FIG. 18, the flow of the reward distribution process will be described, and details of the functional blocks shown in FIG. 17 will also be described herein.

### [Flow of the Reward Distribution Process]

FIG. 18 is a flowchart describing the flow of the reward distribution process. From the left side of FIG. 18, a flowchart describing the flow of the reward distribution process performed on the first-order user terminal 31-1 side, a flowchart describing the flow of the reward distribution process performed on the second-order user terminal 31-2 side, a flowchart describing the flow of the reward distribution process performed on the server 11 side, and a flowchart describing the flow of the reward distribution process performed on the advertiser terminal 33 side are shown in this order. Note that the arrows pointing right and left and connecting the four flowcharts in FIG. 18 represent flows of information. For example, payment and reception of rewards are performed using digital money.

In Step S361, the reward calculation unit 128 of the server 11 calculates the amount of rewards to be claimed to the advertiser terminal 33 periodically referring to the user DB 21, the affiliate content DB 24, and the user guidance information DB 25. In other words, the reward calculation unit 128 counts the number of times users are guided to the advertisement page (the number of times the advertisement page is displayed) from the user guidance time information stored in the user guidance information DB 25 to calculate the amount of rewards according to the number of times.

In Step S362, the transmission control unit 122 transmits information of the calculated claimed amount to the advertiser terminal 33.

In Step S381, the advertiser terminal 33 receives the claimed amount transmitted from the server 11.

In Step S382, the advertiser terminal 33 transmits a reward based on the claimed amount to the server 11.

Accordingly, the reward distribution process performed on the advertiser terminal 33 side is terminated.

In Step S363, the reception control unit 120 of the server 11 receives the reward transmitted from the advertiser terminal 33.

In Step S364, the reward calculation unit 128 deducts a reward for the system administrator.

In Step S365, the reward calculation unit 128 determines whether or not user IDs have been registered up to a settable upper limit thereof pre-set in the affiliate content DB.

When user IDs are determined to have been registered up to the settable upper limit in Step S365, the process proceeds to Step S366.

In Step S366, the reward calculation unit 128 calculates reward amounts according to performance, and then distributes the calculated rewards to the first-order user terminal 31-1 and the second-order user terminal 31-2. In other words, the reward calculation unit 128 distributes the remaining amount obtained by deducting the reward for the system administrator in the process of Step S364 from the total rewards received in the process of Step S363 to the first-order user terminal 31-1 and the second-order user terminal 31-2 according to the numbers of times the users were guided to the advertisement page.

On the other hand, when user IDs are determined not to have been registered up to the settable upper limit in Step S365, the process proceeds to Step S367.

In Step S367, the reward calculation unit 128 deducts a surplus reward so as to further distribute the surplus reward to the system administrator. The surplus reward is the remaining amount obtained, for example, when a reward is divided among users whose user IDs are registered at the same ratio as when user IDs are registered up to the settable upper limit. Then, the process proceeds to Step S366.

In Step S366 after the process of Step S367, the reward calculation unit 128 calculates the amount of reward according to performance, and then distributes the calculated reward to the first-order user terminal 31-1 and the second-order user terminal 31-2. In other words, the reward calculation unit 128 distributes the remaining amount obtained after deducting the rewards for the system administrator in the process of each of Step S364 and Step S367 from the total amount of reward received in the process of Step S363 to the first-order user terminal 31-1 and the second-order user terminal 31-2 according to the number of times the users were guided to the advertisement page.

Accordingly, the reward distribution process performed on the server 11 side is terminated.

In Step S331, the reception control unit 154 of the first-order user terminal 31-1 receives the reward transmitted from the server 11.

Accordingly, the reward distribution process performed on the first-order user terminal side is terminated.

In Step S341, the reception control unit 154 of the second-order user terminal 31-2 receives the reward transmitted from the server 11.

Accordingly, the reward distribution process performed on the second-order user terminal side is terminated.

As disclosed in JP 2010-086331A in the related art, a reward from an advertiser is only paid to the administrator of a link source site, and not paid to users who share multimedia content in a later stage. According to the information processing system 1 of the present technology, however, a reward from an advertiser can be paid to users U who share UGC in a later stage.

### [Modified Example]

In the example described above, when a keyword extracted from content is compared to a keyword relating to an advertisement page and the keywords coincide with each other, the URI of the advertisement page is associated with the content. A target of the comparison, however, is not limited to keywords, and may be images and sounds.

In addition, in the example described above, the upper limit of the number of user IDs that can be registered is set in advance in the affiliate content DB 24. In other words, the number of users who can reuse affiliate content is set in advance by the system administrator or the advertiser. The number of users who can reuse affiliate content, however, can also be set by the first-order user.

### [Application of the Present Technology to a Program]

The series of processes described above can be executed by hardware or can be executed by software. When the series of processes is executed by software, a program of the software is installed in a computer. Here, the computer includes a computer incorporated into dedicated hardware, a computer that can execute various functions using various programs installed therein, for example, a general-purpose personal computer, and the like.

For example, the series of processes described above is performed in the server 11 of FIG. 3 or the user terminal 31 of FIG. 5 that is an example of a computer when the CPU 51 of FIG. 3 or the CPU 81 of FIG. 5 loads a program stored in, for example, the storage unit 58 of FIG. 3 or the storage unit 89 of FIG. 5 in the RAM 53 of FIG. 3 or the RAM 83 of FIG. 5 for execution via the input and output interface 55 of FIG. 3 or the input and output interface 85 of FIG. 5 and the bus 54 of FIG. 3 or the bus 84 of FIG. 5.

A program executed by the computer can be provided by being recorded on, for example, the removable medium 61 of FIG. 3 or the removable medium 92 of FIG. 5 as a package medium or the like. In addition, the program can be provided via a wired or wireless transmission medium such as a local area network, the Internet, or digital satellite broadcasting.

In the computer, such a program can be installed in the storage unit 58 of FIG. 3 or the storage unit 89 of FIG. 5 by loading the removable medium 61 of FIG. 3 or the removable medium 92 of FIG. 5 in the drive 60 of FIG. 3 or the drive 91 of FIG. 5 via the input and output interface 55 of FIG. 3 or the input and output interface 85 of FIG. 5. In addition, the program can be received by the communication unit 59 of FIG. 3 or the communication unit 90 of FIG. 5 via a wired or wireless transmission medium and installed in the storage unit 58 of FIG. 3 or the storage unit 89 of FIG. 5. In addition, the program can be installed in advance in the ROM 52 of FIG. 3 or the ROM 82 of FIG. 5 or the storage unit 58 of FIG. 3 or the storage unit 89 of FIG. 5.

It should be noted that the program executed by a computer may be a program that is processed in time series according to the sequence described in this specification or a program that is processed in parallel or at necessary timing such as upon calling.

An embodiment of the present technology is not limited to the embodiments described above, and various changes and modifications may be made without departing from the scope of the present technology.

For example, the present technology can adopt a configuration of cloud computing which processes by allocating and sharing one function by a plurality of apparatuses through a network.

In addition, each step described by the above-mentioned flowcharts can be executed by one apparatus or by being allocated to a plurality of apparatuses.

Furthermore, in the case where a plurality of processes is included in one step, the plurality of processes included in this one step can be executed by one apparatus or by being allocated to a plurality of apparatuses.

Additionally, the present technology may also be configured as below.

(1)

An information processing device including:

an association unit configured to associate content of which a first post destination is designated by a first user with a predetermined advertisement; and

a transmission control unit configured to transmit the content associated with the predetermined advertisement by the association unit to the first post destination as affiliate content, and when the affiliate content is reproduced in the first post destination and then a second post destination is designated by a second user, to transmit a duplicate of the affiliate content of which the second post destination has been designated to the second post destination.

(2)

The information processing device according to (1), further including:

an extraction unit configured to extract a keyword by analyzing the content,

wherein, when the keyword extracted by the extraction unit coincides with a keyword that relates to the predetermined advertisement, the association unit associates the content and the predetermined advertisement.

(3)

The information processing device according to (1) or (2), wherein the transmission control unit performs redirection to the predetermined advertisement when an instruction to reproduce the affiliate content is accepted.

(4)

The information processing device according to any one of (1) to (3), further including:

a reward calculation unit configured to record a number of times of reproduction of the predetermined advertisement after the instruction to reproduce the affiliate content is accepted and then to calculate an amount to be claimed to an advertiser based on the number of times.

(5)

The information processing device according to any one of (1) to (4), wherein the reward calculation unit calculates amounts of rewards for each of the first user and the second user based on the amount to be claimed.

(6)

An information processing system including:

a user terminal configured to include an acceptance unit configured to accept designation of a first post destination of content from a first user, and a transmission control unit configured to transmit the content of which the first post destination has been designated to a server; and

a server configured to include an association unit configured to associate the content that has been received from the user terminal and of which the first post destination is designated by the first user with a predetermined advertisement, and a transmission control unit configured to transmit the content associated with the predetermined advertisement by the association unit to the first post destination as affiliate content, and when the affiliate content is reproduced in the first post destination and then a second post destination is designated by a second user, to transmit a duplicate of the affiliate content of which the second post destination has been designated to the second post destination.

The present technology can be broadly applied to information processing devices such as servers that are used in the field of advertisement-providing service.

### REFERENCE SIGNS LIST

1 information processing system
11 server
31 user terminal
32 media managing server
33 advertiser terminal
120 reception control unit
121 authentication unit
122 transmission control unit 122
123 extraction unit
124 collation unit
125 association unit
126 affiliate content creation unit
127 user ID management unit
128 reward calculation unit
151 content acquisition unit
152 acceptance unit
153 transmission control unit
154 reception control unit
155 output control unit
156 analysis unit

1. An information processing device comprising: /
an association unit configured to associate content of which a first post destination is designated by a first user with a predetermined advertisement; and
a transmission control unit configured to transmit the content associated with the predetermined advertisement by the association unit to the first post destination as affiliate content, and when the affiliate content is reproduced in the first post destination and then a second post destination is designated by a second user, to transmit a duplicate of the affiliate content of which the second post destination has been designated to the second post destination.

2. The information processing device according to claim 1, further comprising:
an extraction unit configured to extract a keyword by analyzing the content,
wherein, when the keyword extracted by the extraction unit coincides with a keyword that relates to the predetermined advertisement, the association unit associates the content and the predetermined advertisement.

3. The information processing device according to claim 2, wherein the transmission control unit performs redirection to the predetermined advertisement when an instruction to reproduce the affiliate content is accepted.

4. The information processing device according to claim 3, further comprising:
a reward calculation unit configured to record a number of times of reproduction of the predetermined advertisement after the instruction to reproduce the affiliate content is accepted and then to calculate an amount to be claimed to an advertiser based on the number of times.

5. The information processing device according to claim 4, wherein the reward calculation unit calculates amounts of rewards for each of the first user and the second user based on the amount to be claimed.

6. An information processing method comprising steps of:
associating content of which a first post destination is designated by a first user with a predetermined advertisement; and
transmitting the content associated with the predetermined advertisement to the first post destination as affiliate content, and when the affiliate content is reproduced in the first post destination and then a second post destination is designated by a second user, transmitting a duplicate of the affiliate content of which the second post destination has been designated to the second post destination.

7. A program causing a computer to function as:
an association unit configured to associate content of which a first post destination is designated by a first user with a predetermined advertisement; and
a transmission control unit configured to transmit the content associated with the predetermined advertisement by the association unit to the first post destination as affiliate content, and when the affiliate content is reproduced in the first post destination and then a second post destination is designated by a second user, to transmit a duplicate of the affiliate content of which the second post destination has been designated to the second post destination.

8. An information processing system comprising:
a user terminal configured to include an acceptance unit configured to accept designation of a first post destination of content from a first user, and a transmission control unit configured to transmit the content of which the first post destination has been designated to a server; and
a server configured to include an association unit configured to associate the content that has been received from the user terminal and of which the first post destination is designated by the first user with a predetermined advertisement, and a transmission control unit configured to transmit the content associated with the predetermined advertisement by the association unit to the first post destination as affiliate content, and when the affiliate content is reproduced in the first post destination and then a second post destination is designated by a second user, to transmit a duplicate of the affiliate content of which the second post destination has been designated to the second post destination.
